(19) United States
(12) Patent Application Publication
(10) Pub. No.: US 2024/0191422 A1
(43) Pub. Date: Jun. 13, 2024

(54) OBJECT TREATMENT APPARATUS

(71) Applicant: LG ELECTRONICS INC., Seoul (KR)

(72) Inventors: Daewoong KIM, Seoul (KR); Jeongguen CHOI, Seoul (KR); Minkyu OH, Seoul (KR); Yuna JO, Seoul (KR); Jaemyung LIM, Seoul (KR); Hyunki KIM, Seoul (KR); Myounghoon KWAK, Seoul (KR); Sunggul HWANG, Seoul (KR)

(21) Appl. No.: 18/538,099

(22) Filed: Dec. 13, 2023

(30) Foreign Application Priority Data
Dec. 13, 2022 (KR) 10-2022-0173835
Apr. 4, 2023 (KR) 10-2023-0044261

(51) Int. Cl. D06F 58/10; F26B 3/04; F26B 9/06

(52) U.S. Cl. CPC D06F 58/10; F26B 3/04; F26B 9/06

(57) ABSTRACT

Provided is an object treatment apparatus including a cabinet having an inlet formed in a front surface thereof, a door coupled to the cabinet to open and close the inlet, a first chamber located inside the cabinet and accommodating an object put through the inlet, a second chamber located inside the cabinet and defining a space separated from the first chamber, and a circulator disposed in the second chamber and circulating air of the first chamber, and in this case, the circulator includes a connection duct including a circulating fan circulating air and an air processor processing air, a first flow path including the connection duct and communicating with the first object processing room to circulate air of first object processing room therethrough, and a second flow path including the connection duct and communicating with the second object processing room to circulate air of the second object processing room.

### CROSS-REFERENCE TO RELATED APPLICATION(S)

This application claims the benefit of Korean Patent Application Nos. 10-2022-0173835, filed on Dec. 13, 2022 and 10-2023-0044261, filed on Apr. 4, 2023, which is hereby incorporated by reference as if fully set forth herein.

### BACKGROUND

### 1. Field

The present disclosure relates to an object treatment apparatus. More particularly, the present disclosure relates to an object treatment apparatus that dehumidifies and manages air in a space that accommodates objects such as clothes and items.

### 2. Background

An object treatment apparatus refers to an apparatus developed to provide an environment such as appropriate humidity for objects that encompasses items such as hats, scarves, handkerchiefs, and dolls and things such as watches and trinkets to preserve or store the object in an optimal state and simultaneously display the object to the outside.

Korean Patent Publication No. 10-2014-0108454 discloses a general laundry treatment apparatus. In other words, in the case of a general laundry treatment apparatus, a processing room that accommodates clothes inside a cabinet and manages the clothes using steam and hot air is formed, and a hanger bar that holds the clothes is located left and right inside the processing room. A machine room including machine devices required for laundry management is located in a lower portion of the processing room to supply hot air and steam to the processing room. When clothes are mounted on the hanger bar using a hanger, the clothes may be arranged in a front and rear direction of the cabinet. The processing room may have a shelf that mounts items required to be managed, such as bags and hats.

However, this is an apparatus that focuses on treatment and management of clothes, and thus there is no separate space to display or store clothes inside.

Even if the amount of clothing to be managed is small, the processing room may be not efficient in terms of energy. When a front surface of a door is formed of a transparent material to allow a user to check clothes mounted inside the laundry treatment apparatus, there is a problem in that it is difficult to achieve an object of laundry management due to degraded insulation performance through the front surface of the door.

As clothes and items made of various materials are developed, there is a need for a space for separately storing and displaying clothes that need to be delicately managed, such as a leather product or a silk product, or a separate space for adjusting the usual temperature and humidity to keep and display items such as bags or hats.

Korean Patent Publication No. 10-2019-0141286 discloses a laundry treatment apparatus including a processing room that accommodates and manages clothes and a separate storage room that stores the completely managed clothes and controls the temperature. However, there is a serious problem that the processing room and the storage room are arranged left and right to increase the volume of the laundry treatment apparatus indoors. Accordingly, there is a problem that it is difficult to evenly spray steam or air in the processing room and the storage room. In the above reference, there is no showcase room for showcase, and thus there is a problem that it is not possible to arrange only clothes that the user wants to be visible from the outside.

Korean Patent Publication No. 10-2019-0139400 discloses a laundry treatment apparatus including a processing room and a storage room that are partitioned in a front and rear direction, and in this case, the processing room provides a laundry management function alone, and there is a no separate mechanical equipment for managing the temperature and humidity of the storage room. When clothes that are completely treated and managed are simply stored, the stored clothes may be affected by changes in the surrounding temperature and humidity. For example, when clothes are stored without control of temperature and humidity, this may have an effect of increasing a humidity level of the clothes and making the clothes damp or adsorbing surrounding odors again. To resolve this, there is a need for a device that manages the temperature and humidity of clothes if necessary even when the clothes are stored.

The above reference discloses a structure in which a front processing room and a rear storage room are integrated into or separated from each other while a separation plate for distinguishing therebetween is unfolded or folded. However, an object of this structure is to seal a space between the processing room and the storage room to prevent moisture or pollutants inside the processing room from moving to the storage room.

In other words, a main object of the separation plate of the above reference is to seal the space between the processing room and the storage room, and the separation plate is a structure that is open for a while when clothes in the storage room are moved to the storage room. Therefore, when the separation plate is temporarily folded and the processing room and the storage room are open (expanded), the separation plate remains as it between the storage room and the processing room, and thus there is a problem that the separation plate harms the aesthetics and reduces the space between the storage room and the processing room accordingly.

This structure in the above reference is provided only in a flow-channel processing room for supplying or sucking air and is not provided in the storage room, and thus there is a problem in that it is difficult to treat clothes stored in the storage room. The storage room in the above reference only has the meaning as a space for loading clothes, and thus has a problem that a state of refreshed clothes is not maintained for a long time. In other words, the above reference has a problem that it is difficult to treat clothes in the processing room alone among the processing room and the storage room.

A display space is used as a space for not only displaying objects, such as accommodated clothes and goods aesthetically, but also as a space for properly preserving the objects, a storage space preserves the objects, such as accommodated clothes and goods, in a different condition from the display space through a separate flow path from the display space, and there is a need to accommodate an object with a high volume by integrating the display space and the storage space into each other if necessary.

The above references are incorporated by reference herein where appropriate for appropriate teachings of additional or alternative details, features and/or technical background.

### BRIEF DESCRIPTION OF THE DRAWINGS

The embodiments will be described in detail with reference to the following drawings in which like reference numerals refer to like elements wherein:

FIG. 1 is a perspective view of an object treatment apparatus according to an embodiment of the present disclosure;

FIG. 2A is a perspective view of an object treatment apparatus in a state in which a door is open;

FIG. 2B is a perspective view of a state in which a door and a partition are open and a partial enlarged view of a lower portion of a cabinet;

FIG. 3A is a projection diagram illustrating a state in which a partition partitions a first chamber into a first object processing room and a second object processing room;

FIG. 3B is a projection diagram illustrating a state in which a partition is opened and a first object processing room and a second object processing room of a first chamber are integrated into each other;

FIG. 4 is a schematic diagram of a first object processing room, a second object processing room, and a second chamber of an object treatment apparatus according to an embodiment of the present disclosure;

FIG. 5 is a cross-sectional view of an object treatment apparatus taken in a front and rear direction (X-axis direction), according to an embodiment of the present disclosure and a partial enlarged view of a cross section of a portion of a cabinet;

FIG. 6A is a plan view of a lower portion of a cabinet of an object treatment apparatus according to an embodiment of the present disclosure;

FIG. 6B is a plan view of a lower portion of a cabinet of an object treatment apparatus according to another embodiment of the present disclosure;

FIG. 7 is a plan view of a circulator viewed from the above;

FIG. 8A is a perspective view of a front side of a circulator;

FIG. 8B is a perspective view of a rear side of a circulator;

FIG. 9 is a perspective view of a circulator viewed from below;

FIG. 10 is an exploded perspective view of a circulator;

FIG. 11 is a cross-sectional view according to a width direction (Y-axis direction) based on a regeneration flow path of a circulator;

FIG. 12 is a partial diagram showing a regeneration flow path and the case in which water is drained from a regeneration flow path, according to an embodiment of the present disclosure;

FIG. 13 is a diagram showing the case in which air circulates in a circulator along a first flow path;

FIG. 14 is a diagram showing the case in which air circulates in a circulator along a second flow path; and

FIG. 15 is a diagram showing the case in which air circulates in a circulator along a third flow path.

### DETAILED DESCRIPTION

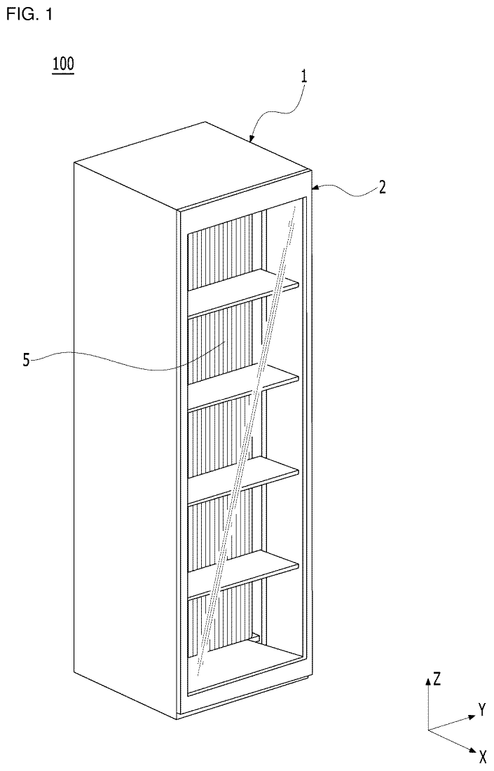

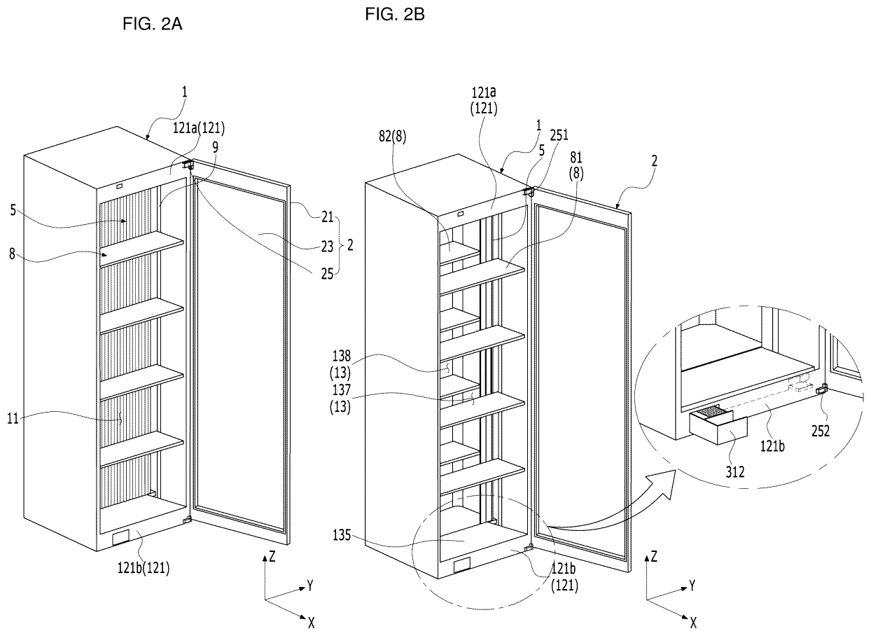

FIG. 1 is a perspective view of an object treatment apparatus according to an embodiment of the present disclosure, FIG. 2A is a perspective view of the object treatment apparatus in a state in which a door is open, and FIG. 2B is a perspective view of a state in which a door and a partition are open and a partial enlarged view of a lower portion of a cabinet.

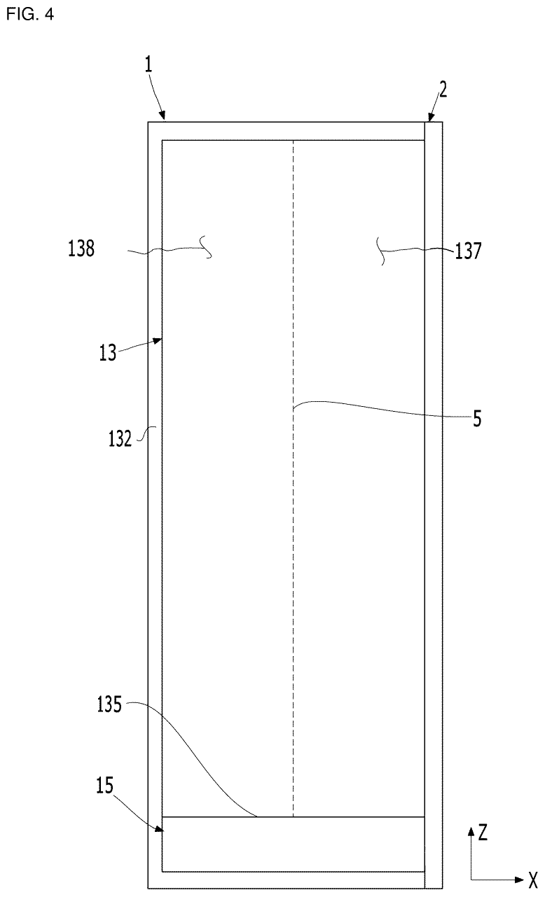

Referring to FIGS. 1 to 2, an object treatment apparatus 100 according to the present disclosure includes a cabinet 1 having a front surface with an inlet 11 formed therein, a door 2 coupled to the cabinet 1 to open and close the inlet 11, a first chamber 13 located inside the cabinet 1 and accommodating an object put through the inlet 11, a second chamber 15 (see FIG. 4) defining a separate space from the first chamber 13, and a partition or a wall 5 that partitions or separates the first chamber 13 into a first object processing room 137 and a second object processing room 138. The partition may be similar or same as a rolling shutter or a slat wall curtain.

The cabinet 1 is provided with the inlet 11 on a front surface 121, and an object may be put through the inlet 11. The entire front surface 121 of the cabinet 1 may be provided as the inlet 11, and the inlet 11 may be formed to pass through a portion of the front surface 121. When the inlet 11 is formed to pass through a portion of the front surface 121 of the cabinet 1, the front surface 121 may include an upper panel 121a disposed above the inlet 11 and a lower panel 121b disposed below the inlet 11.

The first chamber 13 may be provided in an inner space of the cabinet 1. A front side of the first chamber 13 may be in communication with the inlet 11. That is, it is possible to access the first chamber 13 through the inlet 11.

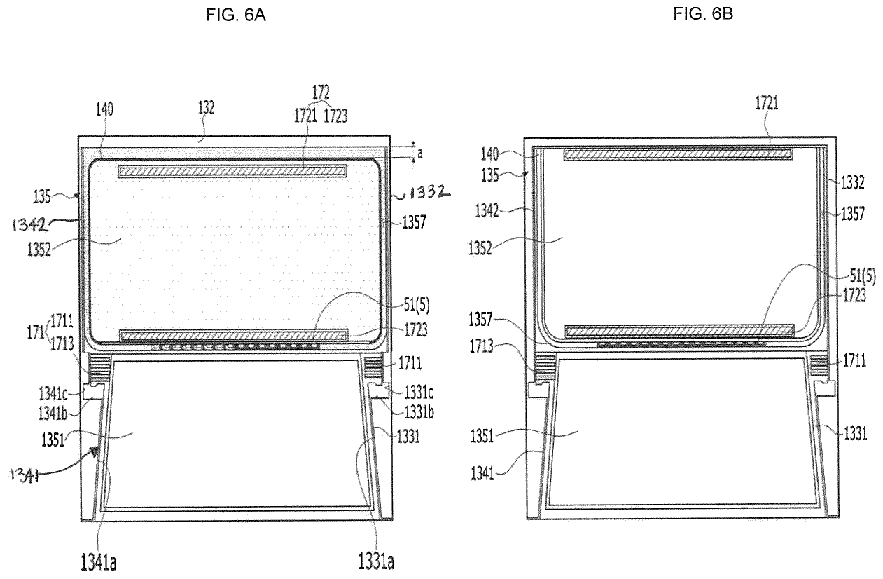

The first chamber includes a first chamber rear side surface 132 (refer to FIG. 6) disposed on a rear side to face the inlet 11, a first chamber left side surface 133 (refer to FIG. 6) disposed on a left side of both sides of the first chamber 13, a first chamber right side surface 134 (refer to FIG. 6) disposed on a right side of both sides of the first chamber, a first chamber bottom surface 135 (refer to FIG. 4) defining a lower surface of the first chamber, and a first chamber upper surface defining an upper surface of the first chamber.

The first chamber 13 may accommodate an object put through the inlet 11 in an inner space defined by the first chamber rear side surface 132, the first chamber left side surface 133, the first chamber right side surface 134, the first chamber bottom surface 135, and the first chamber upper surface.

The first chamber 13 may be a space that preserves or stores an object such as accommodated clothes, items, or goods and thus may also be referred to as a storage room, a preservation room, a processing room, a showcase room, and a receiving chamber.

The second chamber 15 may be provided with a space separated from the first chamber 13 (refer to FIG. 4). The second chamber 15 may define a space separated from a lower portion of the first chamber 13 by the first chamber bottom surface 135. That is, the second chamber 15 may define a space separated from the first chamber 13 in the cabinet 1 through the first chamber bottom surface 135.

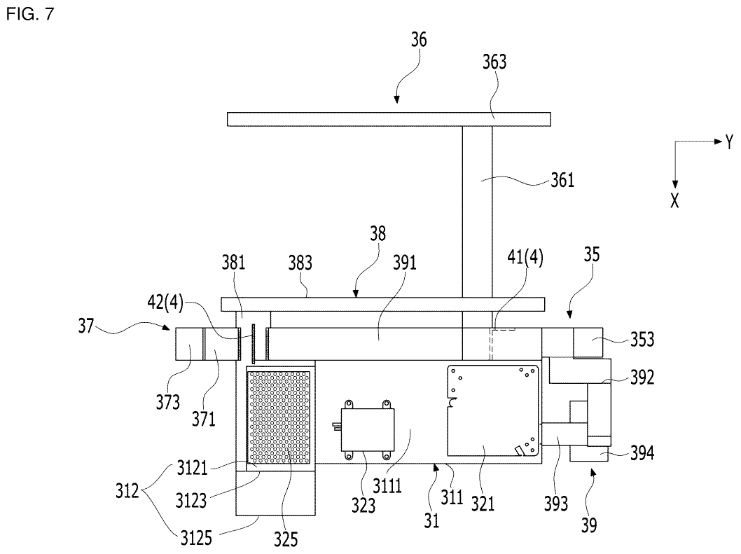

A circulator 3 (refer to FIG. 7) may be provided inside the second chamber 15. The circulator 3 is provided to communicate with the first chamber 13 in the second chamber 15 to circulate air inside the first chamber 13. The circulator 3 will be described below in more detail.

The second chamber 15 is a place in which mechanical equipment for sucking and processing air of the first chamber 13 and then supplying the air into the first chamber 13 and circulating the air is disposed, and thus also be called a machine room or an auxiliary chamber.

The door 2 may be coupled to rotate to the cabinet 1 and may be opened and closed. The door 2 may include a door frame 21 defining a frame of the door 2, a door window 23 surrounded and supported by the door frame 21 and disposed to face at least a portion of the inlet 11, and a door hinge 25 configured to couple the door frame 21 to the cabinet 1 to rotatably couple the door to the cabinet 1.

The door frame 21 may be provided to surround an outer surface of the door window 23. In contrast, the door frame 21 may be coupled to a rear side surface of the door window 23, which faces the inlet 11, such that only the door window 23 is exposed through a front side of the object treatment apparatus 100.

The door window 23 may be disposed to face the inlet 11. The door window 23 may be transmissive to view the inside of the first chamber 13, in more detail, the first object processing room 137 from the outside through the inlet 11. Alternatively or in addition, the door window 23 may include a display, and a camera (not shown) may be provided in the first chamber 13, and accordingly, an object in the first chamber 13 may be displayed through the display of the door window 23. As such, the door window 23 is not particularly limited as long as the door window 23 is provided to view a space inside the first chamber 13.

The door hinge 25 rotatably connects the door frame 21 to the cabinet 1. The door hinge 25 may include an upper hinge 251 coupled to the upper panel 121a provided on the cabinet front surface 121 and a lower hinge 252 coupled to the lower panel 121b provided below the cabinet front surface 121.

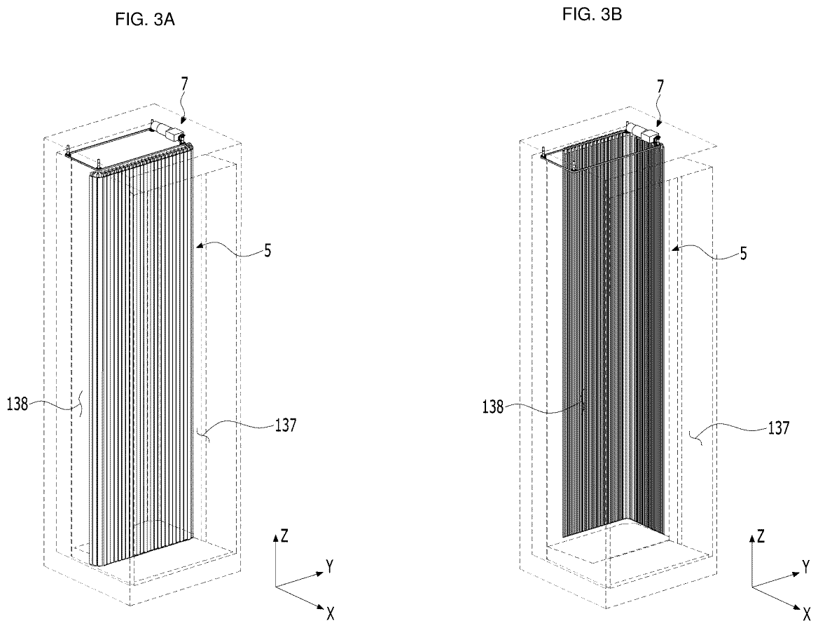

FIG. 3A is a projection diagram illustrating a state in which a partition partitions a first chamber into a first object processing room and a second object processing room. FIG. 3B is a projection diagram illustrating a state in which the partition is opened and the first object processing room and the second object processing room of the first chamber are integrated into each other. FIG. 4 is a schematic diagram of the first object processing room, the second object processing room, and a second chamber of an object treatment apparatus according to an embodiment of the present disclosure.

Referring to FIG. 3A, in the present disclosure, the inside of the first chamber 13 may be partitioned into the first object processing room 137 and the second object processing room 138 through the partition 5. Although the diagram shows the case in which the partition 5 partitions the first chamber 13 in a front and rear direction, the division direction of the first chamber 13 is not necessarily limited thereto.

In detail, the partition 5 is disposed between the first object processing room 137 and the second object processing room 138 to separate the first object processing room 137 and the second object processing room 138 from each other.

Unlike the drawings, the partition 5 may be moved a certain distance and disposed only in a partial area between the first object processing room 137 and the second object processing room 138. In this case, the first chamber 13 may be considered to be partially separated by the partition 5.

That is, the expression “separate” herein means that at least a portion of the partition is positioned between the first object processing room 137 and the second object processing room 138 and that the first object processing room 137 and the second object processing room 138 are at least partially separated from each other and may be used in a comprehensive sense that includes all states rather than the expression “integrated,” which will be explained below.

Referring to FIG. 3B, according to the present disclosure, the partition 5 is opened to integrate the first object processing room 137 and the second object processing room 138 into each other to form the first chamber 13.

In detail, the partition 5 may be moved into the first object processing room 137 or the second object processing room 138 and thus the first object processing room 137 and the second object processing room 138 may communicate with each other.

In this case, a state in which at least a portion of the partition 5 is not disposed between the first object processing room 137 and the second object processing room 138, that is, a state in which the first object processing room 137 completely communicates with the second object processing room 138 may be described as being “integrated”.

That is, when the partition 5 is not disposed between the first object processing room 137 and the second object processing room 138, the first object processing room 137 and the second object processing room 138 may be integrated into each other to form the first chamber 13. Referring to FIG. 4, the partition 5 may partition the chamber 13 into the first object processing room 137 and the second object processing room 138. A lower portion of the partition 5 may be at least partially inserted into a slide groove 1357 (refer to FIG. 6) provided on the first chamber bottom surface 135 and may be moved along the slide groove 1357.

An upper portion of the partition 5 may be connected to a guide assembly (not shown) to be moved along the guide assembly. That is, the upper portion of the partition 5 may be guided by the guide assembly inside the first chamber 13 above the first chamber 13, and a lower portion of the partition 5 may be guided and moved by the slide groove 1357.

The meaning of communication here includes all meanings that the partition slides and the first object processing room 137 and the second object processing room 138 at least partially communicate with each other and that the first object processing room 137 and the second object processing room 138 are integrated or expanded to form the inside of the first chamber.

The partition 5 may partition the first chamber 13 in various ways according to the purpose of the first chamber 13. For example, the first chamber 13 may be partitioned into the first object processing room 137 facing the first inlet 11 and the second object processing room 138 disposed behind the first object processing room 137 in the front and rear direction of the cabinet 1 by the partition 5. Alternatively, the first chamber 13 may be partitioned into the first object processing room 137 communicating with the inlet 11 and the second object processing room 138 that does not communicate with the inlet 11 by the partition 5.

That is, there may be the first object processing room 137 and the second object processing room 138 separated by the partition 5 in the first chamber 13, and the second object processing room 138 may be disposed behind the first object processing room 137.

In this case, it may be possible to access the inside of the first object processing room 137 through the inlet 11. In addition, it may be possible to access the second object processing room 138 through the first object processing room 137. The first object processing room 137 may be provided to face the door 2 as well as the inlet 11 to be visible from the outside.

Through this partitioning method of partitioning the cabinet 13 in the front and rear direction, the first chamber 13 may function as a space for showcase as the main purpose by exposing the first object processing room 137 to the outside through the inlet 11, and the second object processing room 138 may function as a space for storage as the main purpose rather than being internally exposed by the partition 5.

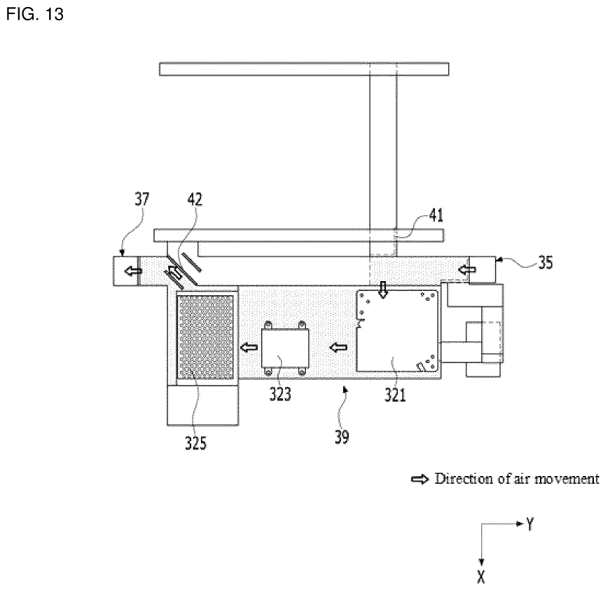

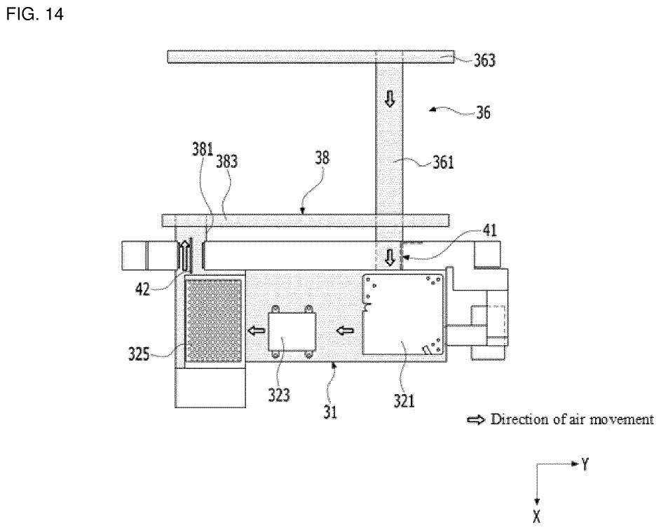

In another example, the first chamber 13 may be partitioned into a space (first object processing room) in which air circulating along a first flow path (refer to FIG. 13) to be described below flows and a space (second object processing room) in which air circulating along a second flow path (refer to FIG. 14) flows, by the partition 5.

That is, the inside of the cabinet 13 may be partitioned into the space in which air circulates along the first flow path and the space in which air circulates along the second flow path.

Through this partitioning method, the first object processing room 137 may be used as a space for storing an object suitable for the temperature and humidity conditions of air that flows in the first flow path, and the second object processing room 138 may be used as a space for storing an object suitable for the temperature and humidity conditions of air that flows in the second flow path.

In another example, the first chamber 13 may be partitioned into a space (first object processing room) communicating with a first air port 171 (refer o FIG. 6) and a space (second object processing room) communicating with a second air port 172 (refer to FIG. 6).

Through this partitioning method, the size or material of the object may be stored differently depending on the amount of air flowing through the first air port 171 or the second air port 172.

In another example, the first chamber may be partitioned into the first object processing room 137 and the second object processing room 138 with a greater volume than the first object processing room 137 by the partition 5.

Through this partitioning method, the first object processing room 137 may store an object with a relatively small volume (e.g., wallet or necklace), and the second object processing room 138 may store an object with a relatively large volume (e.g., handbag or bag).

Hereinafter, like in the example described above with reference to FIG. 4, the present disclosure will be described in terms of the case in which the first chamber 13 is partitioned into the first object processing room 137 and the second object processing room 138 disposed behind the first object processing room 137 by the partition 5 (the first chamber 13 is partitioned in a front and rear direction).

In this case, the first object processing room 137 is a space in which an object focused on display is stored, and thus may be referred to as a showcase space or a display space. The second object processing room 138 may be a space for storage of an object rather than display of the object and may be referred to as a storage space, a preservation space, or a processing space.

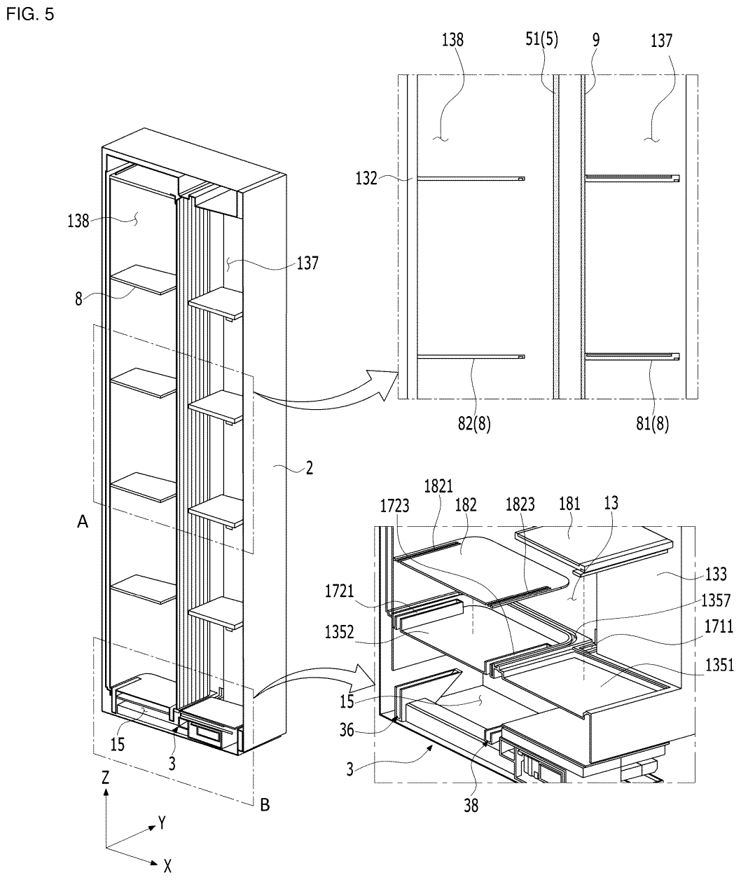

FIG. 5 is a cross-sectional view of an object treatment apparatus taken in a front and rear direction (X-axis direction), according to an embodiment of the present disclosure and a partial enlarged view of a cross section of a portion of a cabinet.

Referring to FIG. 5, the first chamber 13 may include a shelf unit 8 and a lighting unit 9. The shelf unit 8 may include a first shelf 81 disposed in the first object processing room 137 and a second shelf 82 disposed in the second object processing room 138.

The first shelf 81 may be disposed in the first object processing room 137 and may be coupled to an inner circumference of the first chamber 13. The inlet 11 may be disposed on the front side of the first object processing room 137, and the partition 5 or the second object processing room 138 may be disposed behind the first object processing room 137.

In this case, the partition 5 is not fixed in the first chamber 13, and thus it is difficult to couple the first shelf 81 to the partition 5. This is because, if the first shelf 81 is coupled to the first shelf 81, an object accommodated on the first shelf 81 is possible to fall or it is difficult to smoothly move the partition 5.

The inlet 11 and the second object processing room 137 are corresponding to a space, and thus it is impossible to couple the first shelf 81 thereto.

Accordingly, the first shelf 81 according to an embodiment of the present disclosure may be coupled to a left side surface 133 of the first chamber 13 and a right side surface 134 of the first chamber 13. In detail, one side of the first shelf 81 may be coupled to a first left side surface 1331 (refer to FIG. 6), and the other side may be coupled to a first right side surface 1341 (refer to FIG. 6).

The second shelf 82 is disposed in the second object processing room 138. The partition 5 or the first object processing room 137 is disposed in front of the second object processing room 138, and thus it is difficult to couple the second shelf 82 to a front side of the second object processing room 138.

A lateral side of the second object processing room 138 is a space to which the second object processing room 138 is moved (refer to FIG. 6), and thus it is difficult to couple the second shelf 82 to side surfaces 133 and 134 of the first chamber 13 at a lateral side of the first chamber 13.

Behind the second object processing room 138, the second shelf 82 may be coupled to an inner case 140 (refer to FIG. 6A) or may be coupled to a rear side surface 132 of the first chamber 13 in some embodiments of the partition 5.

In more detail, according to an embodiment, the partition 5 may be disposed to be moved along a circumference of the second object processing room 138 (refer to FIG. 6A). In this case, the partition 5 is moved along front, lateral, and rear sides of the second object processing room 138, and thus it is difficult to directly fix the second shelf 82 to a rear side surface 132 of the first chamber 13.

The inner case 140 may be provided inside the second object processing room 138 and may be spaced apart at a certain spacing from side surfaces 133 and 134 and the rear side surface 132 of the first chamber 13.

That is, the inner case 140 is provided to surround the second object processing room 138 in a form extending to both sides from a rear side of the second object processing room 138, and one open side of the inner case 140 may face the first object processing room 137. Through this, the inner case 140 may be provided in the form of surrounding the lateral and rear sides except the front side of the second object processing room 138.

As a result, the partition 5 may be moved between a side surface of the inner case 140 and the side surfaces 133 and 134 of the first chamber 13 and between a rear side surface of the inner case 140 and the rear side surface 132 of the first chamber 13.

The slide groove 1357 may be provided by recessing the bottom surface 135 between the inner case 140 and the first chamber 13 (refer to FIG. 6A), and the partition 5 may be moved along the slide groove 1357. Therefore, the inner case 140 not only improves aesthetics and but also guides movement of the partition 5 by hiding the partition 5 accommodated inside the second object processing room 138.

The inner case 140 may provide a space to which the second shelf 82 is to be coupled. The inner case 140 may provide a fixed surface for arranging the second shelf 82 in the second object processing room 138 rather than the side surfaces 133 and 134 and the rear side surface 132 of the first chamber 13. That is, the second shelf 82 may be coupled to any one of a left side surface, a right side surface, and a rear side surface of the inner case 140 and disposed inside the second object processing room 138.

According to another embodiment, the partition 5 may be disposed to be moved along a front side and both lateral sides except for a rear side of the second object processing room 138 (refer to FIG. 6B). In this case, the partition 5 is not moved to the rear side of the second object processing room 138, and thus the second shelf 82 may be directly coupled to the rear side surface 132 of the first chamber 13.

The inner case 140 may be provided at both side surfaces of the second object processing room 138, and the second shelf 82 may be coupled to at least one of the rear side surface 132 of the first chamber 13 and the inner case 140.

In other words, in the case of an embodiment in which the partition 5 extends to the rear side of the second object processing room 138 (refer to FIG. 6A), the inner case 140 may be required to fix the second shelf 82. At this time, the second shelf 82 may be coupled to at least one of the left side surface, the right side surface, and the rear side surface of the inner case 140 and may be disposed in the second object processing room 138.

In the case of an embodiment in which the partition 5 does not extend to the rear side of the second object processing room 138 (refer to FIG. 6B), the inner case 140 may not be required to fix the second shelf 82. That is, in this case, the second shelf 82 may be fixed to the rear side surface 132 of the first chamber 13.

FIG. 5 shows the case in which the second shelf 82 is coupled to the rear side surface 132 of the second chamber 15. Referring to an enlarged view of a portion A of FIG. 5, the partition 5 may be provided between the first shelf 81 and the second shelf 82. That is, the partition 5 may be provided between the first shelf 81 and the second shelf 82.

Through the coupling structure of the first shelf 81 and the second shelf 82 described above, movement of the partition 5 may not be hindered by the first shelf 81 and the second shelf 82.

In addition, the lighting unit 9 may be disposed between the first shelf 81 and the second shelf 82. The lighting unit 9 may be coupled to the side surfaces 133 and 134 of the first chamber 13 and may extend in a height direction. The lighting unit 9 is shown to be disposed in the first object processing room 137, but is not limited thereto. The arrangement structure of the lighting unit 9 of the diagram is only an example, and there may be various arrangement structures, such as being provided in the shelf 8 or being provided on the bottom surface 135 (see FIG. 2B).

Referring to an enlarged view of a portion B of FIG. 5, the circulator 3 may be provided inside the second chamber 15. The first chamber 13 and the second chamber 15 are separated by the bottom surface 135 in the cabinet 1. The bottom surface 135 of the first chamber 13 may be provided with a step as shown in the diagram, and lower covers 181 and 182 may be provided to fill the step of the bottom surface 135 of the first chamber 13. The lower covers 181 and 182 may include a first lower cover 181 provided to cover a first bottom surface 1351 as the bottom surface 135 disposed on the first object processing room 137, and a second lower cover 182 provided to cover a second bottom surface 1352 as the bottom surface 135 disposed on the second object processing room 138.

A second air intake port 1721 and a second air discharge port 1723 may communicate the second chamber with the second target processing room 137. The second air intake port 1721 and the second air discharge port 1723 may protrude upward from the second bottom surface 1352.

The second lower cover 182 may include a second intake cover hole 1821 in communication with the second air intake port 1721, and a second discharge cover hole 1823 in communication with the second air discharge port 1723, and the second air port 172 (1721, 1723) may be provided to communicate with the inside of the second object processing room 138 through the second lower cover 182.

As shown in the drawing, an empty space may be formed to the extent that the air port protrudes between the first bottom surface 1351 and the first lower cover 181 and between the second bottom surface 1352 and the second lower cover 182, and the lighting unit 9 or various facilities may be placed in the corresponding space.

The lower covers 181 and 182 may be spaced apart by a protruding height of a first air port 171 from the first chamber bottom surface 135 and may be provided on the first chamber bottom surface 135 to cover the first chamber bottom surface 135.

The lower covers 181 and 182 may include a first lower cover 181 covering the first bottom surface 1351 and a second lower cover 182 covering the second bottom surface 1352.

Through this, the step of the first chamber bottom surface 135 may be removed and air may flow smoothly through the air port.

The first lower cover 181 may include a first intake port cover formed to pass through a position corresponding to a first air intake port 1711 to be described below to allow air to flow through the first air intake port 1711, and a first discharge port cover formed to pass through a position corresponding to a first air discharge port 1713 to allow air to flow through the first air discharge port 1713 (see FIG. 6).

Through this, a flow of air through the first air port 171 (1711, 1713) may be appropriately guided and the first air port 171 may be protected from an external environment.

The second lower cover 182 may include a second intake port cover 1821 formed to pass through a position corresponding to a second air intake port 1721 to be described below to allow air to flow through the second air intake port 1721, and a second discharge port cover 1823 formed to pass through a position corresponding to a second air discharge port 1723 to allow air to flow through the second air discharge port 1723.

Through this, a flow of air through the second air port 172 may be appropriately guided and the second air port 172 may be protected from an external environment.

The lighting unit 9 may be inserted into a certain space between the first chamber bottom surface 135 and the lower covers 181 and 182 and a bottom surface of the first chamber 13 may emit light.

The lower covers 181 and 182 are for effective use of the bottom surface 135, and is not necessary, and is described based on a state without the lower covers 181 and 182.

As described above, the object treatment apparatus according to the present disclosure may include the first shelfs 81 that are spaced apart from each other in a height direction inside the first chamber 13 and the lighting unit 9 provided to illuminate an inner space of the first chamber 13.

As described above, the lighting unit 9 may be embedded inside the shelf unit 8, or may be provided on the first chamber bottom surface 135 and an internal surface of the first chamber 13 to aesthetically emphasize an object accommodated inside the first chamber.

The shelf unit 8 may include the lighting unit 9 therein, and when a mounting surface (not shown) on which an object is mounted may be transmissive, thereby emphasizing the object accommodated on the mounting surface with lighting. As described above, the shelf unit 8 may include the first shelf 81 disposed in the first object processing room 137 and the second shelf 82 disposed in the second object processing room 138.

The first shelf 81 may be coupled to the first chamber 13 in the first object processing room 137. The first object processing room 137 may have a front surface facing the inlet 11 and a rear side surface facing the partition 5. Therefore, a shelf coupler (not shown) may be provided at any one or more of the first left side surface 1331 or the second right side surface 1341 of the first chamber 13, and the first shelf may be coupled to the shelf coupler in the first object processing room 137.

That is, the first shelf 81 may be coupled to any one or more of the first left side surface 1331 (refer to FIG. 6) of the first chamber 13 or the first right side surface 1341 (refer to FIG. 6) of the first chamber 13.

FIG. 6A is a plan view of a lower portion of a cabinet of an object treatment apparatus according to an embodiment of the present disclosure. FIG. 6B is a plan view of a lower portion of a cabinet of an object treatment apparatus according to another embodiment of the present disclosure.

Referring to FIG. 6, the structure of the first chamber 13 may be changed according to a movement structure of the partition 5. For example, as described above, as shown in FIG. 6A, the partition 5 may be moved to surround the second object processing room 138. In this case, the inner case 140 may be provided to separate a movement route of the partition 5 from the storage space and the second shelf 82 inside the second object processing room 138.

In FIG. 6B, the partition 5 may be moved from a front side only to a lateral side of the second object processing room 138. In this case, the inner case 140 is not necessary. In this case, the partition 5 may not move to a rear side of the second object processing room 138, and thus it may be possible to ensure a space as much as a degree by which the partition 5 does not move. A space of the second object processing room 138 may be ensured as much as the thickness of the partition 5 or a space ‘a’ between a rear side surface of the inner case 140 and the rear side surface 132 of the first chamber 13 (refer to a of FIG. 6A).

Referring to FIG. 6, the bottom surface 135 of the first chamber 13 may be provided with first air ports 1711 and 1713 and second air ports 1721 and 1723. The first air ports 1711 and 1713 and the second air ports 1721 and 1723 are comprehensively called an air port.

The air port is provided on the bottom surface 135 of the first chamber 13 to communicate the first chamber 13 and the second chamber 15 with each other. The air port may be communicated with the circulator 3 (refer to a partial enlarged portion B of FIG. 5). Through the air port, air inside the first chamber 13 may be discharged to the circulator 3, and air processed in the circulator 3 may be supplied again to the first chamber 13.

The locations of the air ports 171 and 172 (refer to FIG. 6) in the first chamber 13 may vary depending on the arrangement location of the second chamber 15.

For example, when the second chamber 15 defines a space separated from an upper side of the first chamber 13, the air port may be provided in an upper surface 136 of the first chamber 13.

Based on the drawings, the second chamber 15 defines a separated space below the first chamber 13, and thus the first air port 171 may be formed on the bottom surface 135 of the first chamber 13 to communicate the first chamber and the circulator 3 with each other.

The first chamber bottom surface 135 may include the first bottom surface 1351 provided on the first object processing room 137, and a second bottom surface 1352 provided in the second object processing room 138.

That is, the first bottom surface 1351 may define a bottom surface of the first object processing room 137, and the second bottom surface 1352 may define a bottom surface of the second object processing room 138.

In this case, the bottom surface 135 of the first chamber may be provided with a step by the air ports 171 and 172 protruding upward from the first chamber bottom surface 135.

The air ports 171 and 172 may include the first air ports 1711 and 1713 that are disposed in the first object processing room 137 to communicate the first object processing room 137 and the circulator 3 with each other, and the second air ports 1721 and 1723 that are disposed in the second object processing room 138 to communicate the second object processing room 138 and the circulator 3 with each other.

The first air ports 1711 and 1713 may include the first air intake port 1711 provided to introduce air of the first object processing room 137 to the circulator 3, and the first air discharge port 1713 provided to introduce air of the circulator 3 to the first object processing room.

That is, based on a flow of air flowing through a circulating fan 321 (refer to FIG. 7) of the circulator 3, the first air intake port 1711 may be provided upstream of the circulator 3, and the first air discharge port 1713 may be provided downstream of the circulator 3.

As such, through the first air intake port 1711 provided in the first object processing room 137, air of the first object processing room 137 may flow into the circulator 3, and air may be processed while passing through the circulating fan 321 and an air processor 325 and may then be circulated while being supplied into the first object processing room 137 through the first air discharge port 1713.

In detail, the first air intake port 1711 and the first air discharge port 1713 may be disposed closer to the partition 5 than the inlet 11.

That is, the first air ports 1711 and 1713 may be arranged closer to the rear side than the front side inside the first object processing room 137.

This is because, the inlet 11 is communicated with the outside, and thus when the first air intake port 1711 and the first air discharge port 1713 are arranged close to the inlet 11, circulation of air inside the first object processing room 137 is hindered and it is difficult to manage the first object processing room 137 when the door 2 is opened.

The first shelf 81 may be disposed closer to the inlet 11 than the partition 5 in the first object processing room 137 to view better an object to be mounted on the first shelf 81 from the outside (refer to FIG. 5). When the first air intake port 1711 and the first air discharge port 1713 are arranged closer to the inlet 11, a flow of air by the first air ports 1711 and 1713 may be blocked by the first shelf 81, and thus circulation of the air may be hindered. When there is an object accommodated in the first object processing room 137, circulation of air may be hindered by the object.

In more detail, the first air ports 1711 and 1713 are disposed at the rear side to minimize interference of air circulation by the inlet 11. As described above, the first shelf 81 may be coupled to the side surfaces 133 and 134 of the first object processing room 137.

In this case, when the first shelf 81 is arranged close to the rear side, this may interfere with a flow of air discharged or sucked from the first air ports 1711 and 1713. When the first shelf 81 is arranged close to the front side, that is, the inlet 11, interference with the first air ports 1711 and 1713 may be minimized.

Therefore, the first air intake port 1711 and the first air discharge port 1713 may be provided closer to the partition 5 than the inlet 11 (refer to FIG. 5), and thus air of the first object processing room may be effectively circulated.

The first object processing room 137, in which the first air ports 1711 and 1713 are disposed, may be a space for showcase of the object mainly, unlike the second object processing room 138. Therefore, to more efficiently circulate the first object processing room 137 while limiting the size of the air port 17, the first air intake port 1711 and the first air discharge port 1713 may be spaced apart from each other in a width direction (Y-axis direction) of the chamber 13.

In more detail, the first object processing room 137 may have a greater length of the first chamber in a width direction (Y-axis direction) than a length of the first chamber in a front and rear direction (X-axis direction).

In this case, the first air intake port 1711 and the first air discharge port 1713 may be spaced apart from each other as much as possible, and a flow path of air inside the first object processing room 137 may further extend. Through this, air inside the first object processing room 137 may be more effectively and uniformly circulated.

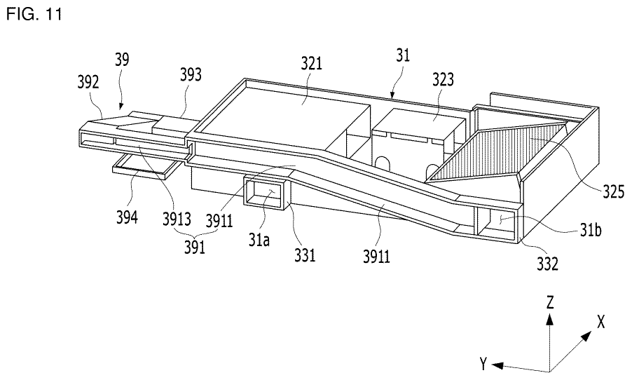

The first air intake port 1711 may be located closer to an inlet hole 31a in a direction parallel to the ground among the inlet hole 31a and a discharge hole 31b of a connection duct 31 to be described below (refer to FIG. 11). Here, a distance in the direction parallel to the ground refers to a horizontal distance between the first air intake port 1711 and the inlet hole 31a or the discharge hole 31b.

Through this arrangement, the length of a first intake duct 35 connecting the first air intake port 1711 and the inlet hole 31a may be reduced and the duct structure may be simplified. When the length of the first intake duct 35 is reduced, a flow loss of air to the connection duct 31 from the first air intake port 1711 may be minimized.

The first air discharge port 1713 may be located closer to the discharge hole 31b in a direction parallel to the ground among the inlet hole 31a and the discharge hole 31b of the connection duct 31.

Through this arrangement, the length of a first discharge duct 37 connecting the first air discharge port 1713 and the discharge hole 31b may be reduced and the duct structure may be simplified. When the length of the first discharge duct 37 is reduced, a flow loss of air to the first air discharge port from the connection duct 31 may be minimized.

The second air ports 1721 and 1723 may include the second air intake port 1721 provided to introduce air of the second object processing room 138 to the circulator 3, and the second air discharge port 1723 provided to introduce air of the circulator 3 to the second object processing room 138.

That is, based on a flow of air flowing through the circulating fan 321 of the circulator 3, the second air intake port 1721 may be provided upstream of the circulator 3, and the second air discharge port 1723 may be provided downstream of the circulator 3.

As such, air inside the second object processing room 138 may be introduced into the circulator 3 through the second air intake port 1721. The air introduced into the circulator 3 may be processed through the air processor 325 and then discharged to the second object processing room 138 through the second air discharge port 1723. Through this, air inside the second object processing room 138 may circulate.

The second air intake port 1721 and the second air discharge port 1723 may be spaced apart from each other along the front and rear direction (X-axis direction) of the first chamber. In detail, the second object processing room 138 may have a greater length in the width direction (Y-axis direction) than in the front and rear direction.

In this case, the second air intake port 1721 and the second air discharge port 1723 may be spaced apart from each other in the front and rear direction, and thus an opening area of each of the second air suction port 1721 and the second air discharge port 1723 may be further increased in the width direction.

In other words, when the second air intake port 1721 and the second air discharge port 1723 are spaced apart from each other in the front and rear direction, the opening area of each of the second air ports 1721 and 1723 may extend in a long way. Through this, it may be advantageous to increase the overall opening area of the second air ports 1721 and 1723. When the entire opening area increases, the amount of air flowing through the second air port increases, and even if the volume of the second object processing room 138 is greater than the volume of the first object processing room 137, air may be smoothly circulated in the entire portion of the second object processing room 138.

When the second air intake port 1721 and the second air discharge port 1723 are spaced apart from each other in the width direction, air circulation by the second air ports 1721 and 1723 may be hindered by the second shelf 82 disposed in the second object processing room 138. Therefore, the second air intake port 1721 and the second air discharge port 1723 may be spaced apart from each other in the front and rear direction, which is advantageous to increase the opening area of the second air ports 1721 and 1723.

The second air intake port 1721 may be arranged closer to a rear surface 132 of the first chamber 13 than the partition 5 of the first chamber 13, and the second air discharge port 1723 may be arranged closer to the partition 5 than the rear surface 132 of the first chamber 13. According to this arrangement, even if the second shelf 82 is provided in the second object processing room 138, air may be smoothly circulated to the upper portion of the second object processing room 138.

In more detail, the second shelf 82 in the second object processing room 138 may be mounted on a shelf mounting portion (not shown) provided on the rear side surface 132 of the first chamber 13 in the embodiment of FIG. 6B.

The partition 5 may slide between the first object processing room 137 and the second object processing room 138, and thus a front side of the second shelf 82 may be spaced apart from the partition 5 by a certain interval (refer to partial enlarged portion A of FIG. 5).

In this case, the second air discharge port 1723 may be provided closer to the partition 5 such that air moves upward through a space between a front side of the second shelf 82 and the partition 5.

When the second air discharge port 1723 is disposed between the second shelf 82 and the partition 5, air discharged from the second air discharge port 1723 may be reached immediately to the upper portion of the second object processing room 138 through the space between the second shelf 82 and the partition 5.

The second air intake port 1721 is a port that sucks air, and thus even if the second air intake port 1721 is placed close to the rear surface 132 of the first chamber 13, air circulation of the second object processing room 138 may not be significantly affected without being disturbed by the second shelf 82.

The second air discharge port 1723 may be arranged such that air processed by the circulator 3 reaches the upper portion of the second object processing room 138, which may be advantageous for air circulation and object processing. On the other hand, even if the second air intake port 1721 is placed on the rear surface 132 of the first chamber 13, this may not have a significant affect air circulation and object processing of the second object processing room 138.

In other words, air that needs to be processed inside the second object processing room 138 is diffused over the entire second object processing room 138, and thus the second air intake port 1721 may be disposed close to the rear surface 132 of the first chamber 13 and the second air discharge port 1723 may be disposed close to the partition 5 in terms of air circulation and object processing.

In addition, the second air discharge port 1723 may be arranged close to the partition 5, and when the first object processing room 137 and the second object processing room 138 are integrated into each other, this may also function as an air curtain to prevent fluids, air and/or particles of the first object processing room 137 and the second object processing room 138 from being mixed with each other.

According to another embodiment, it may be assumed that the volume of the second object processing room 138 is greater than the volume of the first object processing room 137. In this case, when air of the second object processing room 138 is operated with the same output of the circulating fan 321 as in the first object processing room 137, object processing of the second object processing room 138 may be inefficient.

Therefore, according to the present disclosure, a controller (not shown) may be provided to control output of a blower fan in a second circulation mode for circulating air of the second object processing room 138 to be higher than in a first circulation mode for circulating air of the first object processing room, as described below.

The first chamber left side surface 133 may include the first left side surface 1331 provided on the first object processing room 137, and a second left side surface 1332 provided in the second object processing room 138.

The first left side surface 1331 may protrude toward the right side surface 134 and may be provided to be stepped toward a rear side of the first chamber 13 from the inlet 11.

In detail, the first left side surface 1331 may include a left inclined surface 1331a that is inclined to reduce a width length of the first chamber in a direction toward the second object processing room from the inlet 11, a left extension surface 1331b extending to increase the width direction of the first chamber from an end of the left inclined surface 1331a, and a left circulation surface 1331c extending toward the second left side surface 1332 from an end of the left extension surface 1331b.

Similarly, the first chamber right side surface 134 may include a first right side surface 1341 disposed in the first object processing room 137 and a second right side surface 1342 disposed in the second object processing room 138. The first right side surface 1341 may protrude toward the left side surface 133 and may be provided to be stepped toward a rear side of the first chamber 13 from the inlet 11.

In detail, the first right side surface 1341 may include a right inclined surface 1341a that is inclined to reduce a width length of the first chamber in a direction toward the second object processing room from the inlet 11, a right extension surface 1341b extending to increase the width direction of the first chamber from an end of the right inclined surface 1341a, and a right circulation surface 1341c extending toward the second right side surface 1342 from an end of the right extension surface 1341b.

Through this structure, widths of the both side surfaces 1331 and 1341 of the first chamber in the first object processing room 137 may each be stepped to be narrowed by the inclined surfaces 1331a and 1341a of the first object processing room 137 toward the rear side of the first chamber 13 from the inlet 11 and then widened again along the extension surfaces 1331b and 1341b and the circulation surfaces 1331c and 1341c.

The inclined surfaces 1331a and 1341a may be coupled to the first shelf 81 as the shelf 8 disposed in the first object processing room. The first air port 171 may be provided in a space between the circulation surfaces 1331c and 1341c.

The side surfaces 1331 and 1341 may be stepped by the inclined surfaces 1331a and 1341a and the extension surfaces 1331b and 1341b. At this time, the first air port may be provided in a space between the left circulation surface 1331c and the right circulation surface 1341c. That is, to minimize obstruction of air circulation caused by the first shelf 81 or obstruction of air circulation by opening and closing of the inlet 11, the first air port may be provided on a stepped surface of the first chamber 13, in detail, between the left circulation surface 1331c and the right circulation surface 1341c.

In detail, any one of the first air intake port 1711 and the first air discharge port 1713 may be disposed in a stepped space formed by the left extension surface 1331b and the left circulation surface 1331c, and the other one may be disposed in a stepped space formed by the right extension surface 1341b and the right circulation surface 1341c.

That is, a stepped space by which at least a portion of the first port 171 is hidden based on the inlet 11 is formed, and thus a path along which air leaked through the first object processing room 137 may be formed. Through this, air circulation may be effectively achieved inside the first object processing room 137.

The first chamber 13 has a trapezoidal shape in which a space between the left inclined surface 1331a and the right inclined surface 1341a is gradually narrowed toward the rear side of the first chamber or gradually widened toward the front side of the first chamber.

Due to a length difference in the width of the first chamber 13, air may more effectively flow toward the space between the left inclined surface 1331a and the right inclined surface 1341a from the space between the left circulation surface 1331c and the right circulation surface 1341c, in which the first air port is provided.

In other words, the width of the first chamber 13 increases gradually toward the inlet 11 from the rear side of the first object processing room 137, and thus a pressure difference may be formed between front and rear sides of the first object processing room 137, and as a result, air circulation in a front and rear direction may be smoothly achieved in the first object processing room 137.

The first shelf 81 coupled to the inclined surfaces 1331a and 1341a may also have a trapezoidal shape, a width of which increases toward the inlet 11 to correspond to as pace between the inclined surfaces. The shape of the first shelf 81 has an effect of allowing a user who see an object from the outside of the cabinet 1 to readily recognize the object placed and displayed on the first shelf 81.

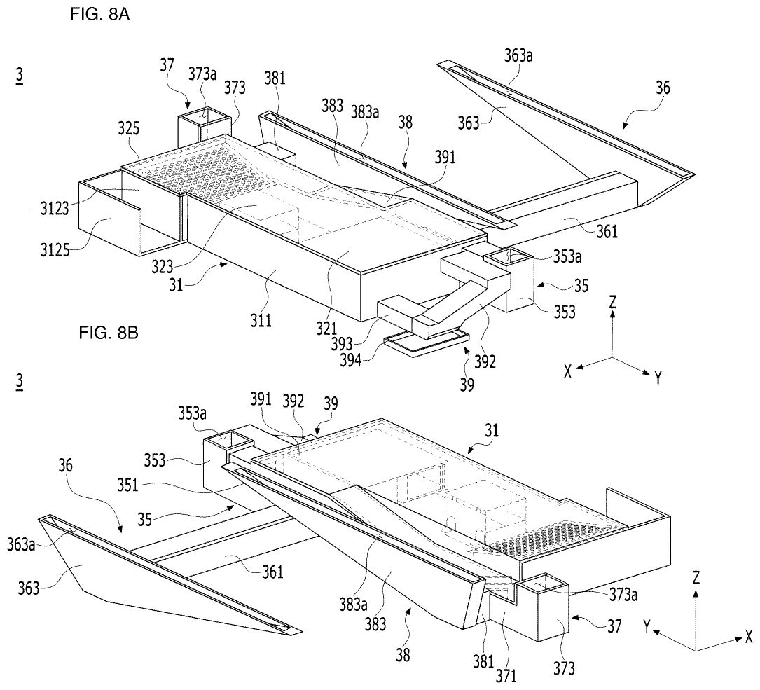

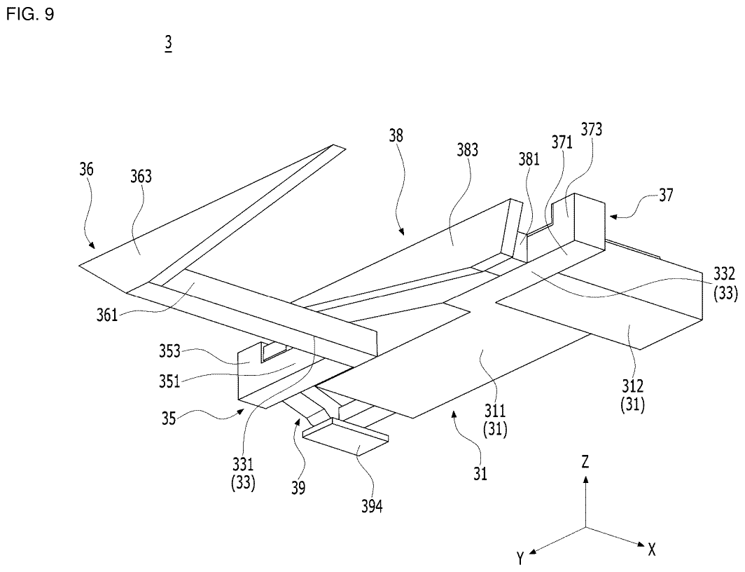

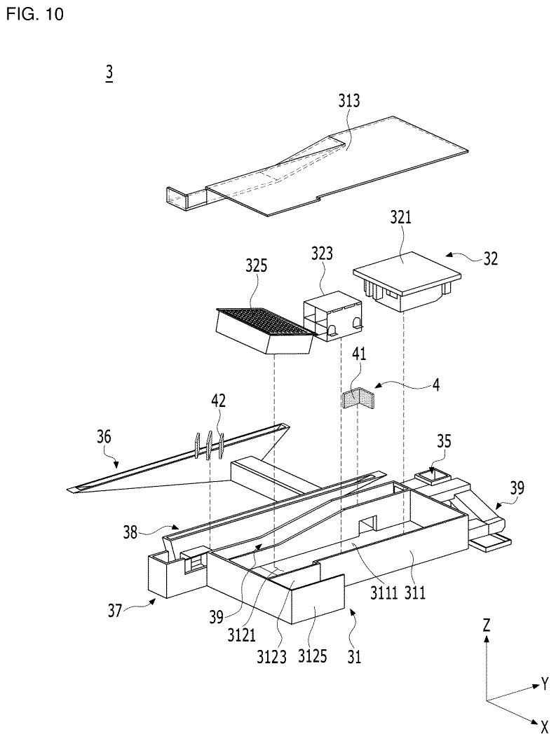

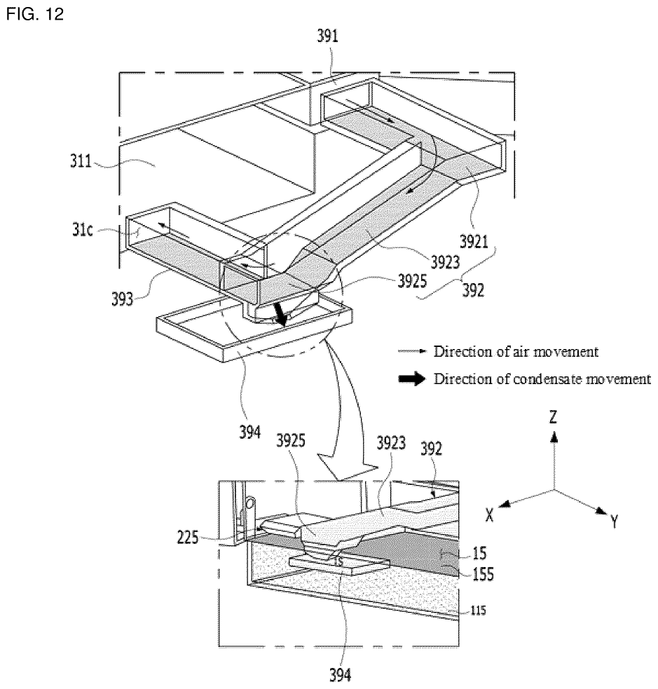

FIG. 7 is a plan view of a circulator viewed from the above. FIG. 8A is a perspective view of a front side of the circulator. FIG. 8B is a perspective view of a rear side of the circulator. FIG. 9 is a perspective view of the circulator viewed from below. FIG. 10 is an exploded perspective view of the circulator. FIG. 11 is a cross-sectional view according to a width direction (Y-axis direction) based on a regeneration flow path of the circulator. FIG. 12 is a partial diagram showing a regeneration flow path and the case in which water is drained from the regeneration flow path, according to an embodiment of the present disclosure.

As described above, the circulator 3 is provided inside the second chamber 15 and is provided to circulate air inside the first chamber 13. The air introduced from the first chamber 13 to the circulator 3 may be dehumidified and filtered while flowing along the circulator 3 and may be introduced to the first chamber 13 again.

Referring to FIG. 7, the circulator 3 may include the connection duct 31 through which the circulating air passes, an air conditioner 32 provided in the connection duct 31 and configured to circulate and process air, the air intake ducts 35 and 36 configured to introduce air inside the first chamber 13 to the connection duct 31, and the air discharge ducts 37 and 38 configured to discharge the air inside the connection duct 31 to the first chamber 13.

The connection duct 31 may include a hub body/connection body 311 on which the air conditioner 32 is accommodated. The connection duct 31 may further include a replacement body 312 that is moveably provided from the hub body 311 to be withdrawn from the lower panel 121b of the cabinet 1 (refer to FIG. 2B). The details of the replacement body 312 are given below.

The connection duct 31 may include a hub cover 313 (refer to FIG. 10) covering the hub or connection body 311 and the replacement body 312. The hub cover is provided to cover the hub/connection body 311 and the replacement body 312.

The air conditioner 32 may be disposed in an inner space of the connection duct 31, and air may flow along the inner space of the connection duct 31. That is, the connection duct 31 may serve to house the air conditioner 32.

The air conditioner 32 may include the blower fan 321 for circulating air, a heater 323 for heating flowing air, and the air processor 325 for processing the flowing air.

The blower fan 321 may be disposed inside the connection duct 31 to form a pressure difference to circulate the air. The air inside the first chamber may be introduced to the circulator 3 by the blower fan 321, and the air of the circulator 3 may be discharged into the first chamber 13.

The heater 323 may be connected to the connection duct 31 and may heat the air passing through the connection duct 31. The heater is provided to increase the temperature inside the first chamber 13 or to regenerate the air processor 325 described below. The air processor may be placed inside the connection duct and may be processed with flowing air. The air processor may include a material that adsorbs and removes moisture or contaminants in the air, such as porous materials, for example, zeolite, or activated carbon. The air heated by the heater 323 flows into the air processor 325 and evaporates the moisture collected in the air processor 325. As a result, the air processor 325 can be regenerated.

However, the air processor is not necessarily limited thereto and is not particularly limited to the material described above as long as the air processor is provided to process air inside the first chamber 13.

In addition, the “processing of air” here needs to be understood as a comprehensive concept that includes dehumidification of removing moisture from air, deodorization of odor particles in the air, and purification or filtration for filtration or adsorption of pollutant particles from air. In other words, when any one or more functions of aforementioned dehumidification, deodorization, filtration, and purification are performed, it needs to be understood to process air.

That is, the present disclosure is designed to showcase and store the object inside the first object processing room 137 and the second object processing room 138 under the optimum environmental conditions, and unlike a heat pump including a separate refrigerant circulation flow path, the volume of the second chamber 15 (machine room) may be reduced.

Based on the air flowing inside the connection duct 31, the air conditioner 32 may be configured in such a way that the blower fan 321 is disposed upstream of the heater 323 and the heater 323 is disposed upstream of the air processor 325.

The heater 323 may be arranged closer to the air processor 325 among the air processor 325 and the blower fan. This is to supply heat to the air processor without heat loss from the heater.

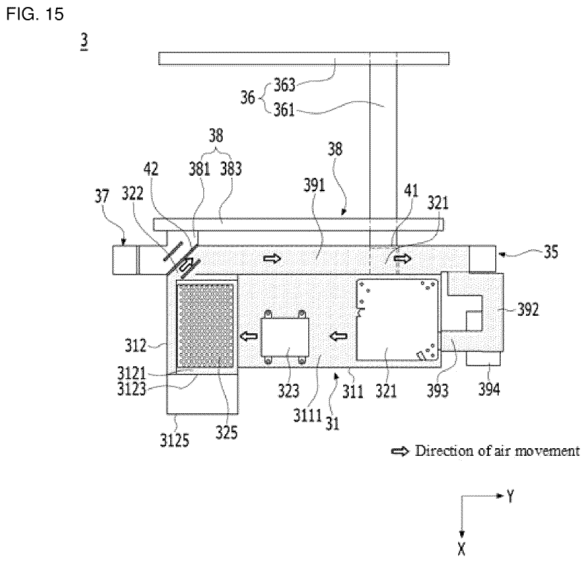

As described below, the connection duct 31 may provide a passage through which a first flow path (refer to FIG. 13) in which air of the first object processing room 137 circulates, a second flow path (refer to FIG. 14) in which air of the second object processing room circulates, and a third flow path (refer to FIG. 15) in which air inside the connection duct 31 circulates or recirculates through the regenerative duct 39 may be commonly passed.

That is, according to an example of the present disclosure, the air of the first object processing room 137 and the second object processing room 138 may be managed while circulating individually by one connection duct 31 having an air conditioner.

The connection duct 31 may include the inlet hole 31a (refer to FIG. 11) into which air of the first chamber is introduced, the discharge hole 31b (refer to FIG. 11) from which air inside the connection duct is discharged, and a regenerative hole 31c (refer to FIG. 12) into which air is introduced into the connection duct through a regenerative duct 39 described below.

In more detail, the inlet hole 31a may be arranged closer to the circulating fan 321 among the circulating fan 321 and the air processor 325. The inlet hole 31a may be provided to face the circulating fan 321. When the inlet hole 31a faces the circulating fan 321, the air inside the first chamber 13 may be introduced into the inlet hole 31a without a flow loss due to breaking or bending of a flow path.

Similarly, the discharge hole 31b may be provided closer to the air processor 325 among the circulating fan 321 and the air processor 325, and to minimize a loss of a flow path, the discharge hole 31b may face the air processor 325.

The air intake ducts 35 and 36 may include the first intake duct 35 communicating the first object processing room 137 and the inlet hole 31a with each other, and the second intake duct 36 communicating the second object processing room 138 and the inlet hole 31a with each other.

Referring to FIGS. 8 to 10, the first intake duct 35 may include a first intake duct body 351 communicating with the connection duct through the inlet hole 31a and a first intake duct guide 353 extending toward the first object processing room 137 from the first intake duct body 351 and connected to the first air intake port 1711.

When the second chamber 15 is provided at a lower portion of the first chamber 13, the first intake duct guide 353 as shown in the drawing may extend upward from an end of the first intake duct body 351, and thus air flowing through the first air intake port 1711 may be guided to the first intake duct body 351.

A first intake duct guide hole 353a may be formed at a free end of the first intake duct guide 353 and may communicate with the first air intake port 1711.

The first intake duct body 351 may provide a flow path in which air flowing from the first intake duct body 351 moves to the inlet hole 31a.

The second intake duct 36 may include a second intake duct body 361 communicating with the connection duct through the inlet hole and a first intake duct guide 353 extending toward the second object processing room from the second intake duct body 361 and connected to the second air intake port 1721.

When the second chamber 15 is disposed at a lower portion of the first chamber 13 (refer to FIG. 4), the second intake duct guide 363 may extend from an end of the second intake duct body 361 to an upper portion of the second intake duct body 361.

The second intake duct guide 363 may be configured with an end connected to the second air intake port 1721 and disposed in parallel to a width direction of the first chamber 13 in the same shape as the second air intake port 1721.

A second intake duct guide hole 363a may be formed at an end of one side of the second intake duct guide 363 and may communicate with the second air intake port 1721.

A width-direction width of the second intake duct guide 363 may be narrowed from the end of the second intake duct guide 363 toward the other end of the second intake duct body 361 or downward from an upper end of the second intake duct guide 363.

Through this shape, air inside the second object processing room 138 may be sucked widely and uniformly. The width of a flow path may be gradually narrowed in a flow direction of air, and thus air may stably flow. As a result, it may be possible to minimize occurrence of turbulent flow in an intake process of air.

The air discharge ducts 37 and 38 may include a first discharge duct 37 communicating the discharge hole 31b with the first object processing room and a second discharge duct 38 communicating the discharge hole 31b with the second object processing room.

The first discharge duct 37 may provide a space in which air discharged from the connection duct 31 through the discharge hole 31b is introduced to the first object processing room.

The first discharge duct 37 may include a first discharge duct body 371 providing a space in which air discharged from the connection duct 31 through the discharge hole 31b flows and a first discharge duct guide 373 extending toward the first object processing room from the first discharge duct body 371 and connected to the first air discharge port 1713.

A first discharge duct guide 373a may be formed at an end of one side (downstream) of the first discharge duct guide 373 and may communicate with the first air discharge port 1713.

When the second chamber 15 is provided at a lower portion of the first chamber 13 (refer to FIG. 4), the first discharge duct guide 373 may extend upward in a direction toward the first air discharge port 1713 from an end of the first discharge duct body 371.

The second discharge duct 38 may provide a space in which air discharged from the connection duct 31 through the discharge hole 31b is introduced to the second object processing room.

The second discharge duct 38 may include a second discharge duct body 381 providing a space in which air discharged from the connection duct 31 through the discharge hole 31b flows and a second discharge duct guide 383 extending toward the second object processing room from the second discharge duct body 381 and connected to the second air discharge port 1723.

When the second chamber 15 is provided at a lower portion of the first chamber 13, the second discharge duct guide 383 may extend upward in a direction toward the second air discharge port 1723 from an end of the second discharge duct 38.

A second discharge duct guide 383a may be formed at an end of one side (downstream) of the second discharge duct guide 383, and the second discharge duct guide 383 may communicate with the second air discharge port 1723 through the second discharge duct guide 383a.

The second discharge duct guide 383 may be configured with an end connected to the second air discharge port 1723 and disposed in parallel to a width direction of the first chamber 13 in the same shape as the second air discharge port 1723.

A width-direction width of the second discharge duct guide 383 may be narrowed from the end of the second discharge duct guide 383 toward the other end of the second intake duct body or downward from an upper end of the second discharge duct guide 383.

Through this shape, the second discharge duct may uniformly supply air discharged from the connection duct 31 to the second object processing room 138. The width of a flow path of the second discharge duct 38 may be gradually narrowed in a flow direction of air, and thus air may stably flow.

As a result, even if the second air discharge port is widely provided with a large length in a width direction, air may be uniformly discharged.

The circulator 3 may further include the regenerative duct 39 provided to introduce again air discharged to the outside of the connection duct 31 from the connection duct 31, to the connection duct 31.

Referring to FIGS. 10 to 12, the regenerative duct 39 may be provided inside the second chamber 15, may have one end connected to the discharge hole 31b and the other end communicating with the regenerative hole 31c to form a closed circulation flow path in which air discharged through the discharge hole 31b from the connection duct 31 is introduced to the regenerative hole 31c again.

As described below, the regenerative duct 39 is provided to regenerate the air processor 325 in a regeneration process.

The regenerative duct 39 may include a first regenerative duct body 391 communicating with the discharge hole 31b and having an inclined section inclined upward or downward, a second regenerative duct body 392 extending from the first regenerative duct 391 and having an inclined section inclined upward or downward, and a third regenerative duct body 393 extending from the second regenerative duct 392 to communicate with the regenerative hole 31c.

The first regenerative duct body 391 may include a first inclined portion 3911 having an end communicating with the discharge hole 31b and including an inclined section inclined upward or downward, and a flat portion 3913 extending toward a side surface of the second chamber from a point at which the inclined section of the first inclined portion 3911 ends.

The first inclined portion 3911 may be inclined such that at least a portion of the regenerative duct 39 is disposed above or below the first air intake port 1711 or the second air intake port 1721.

Based on the drawings, the first inclined portion 3911 is inclined upward, and the flat portion extends towards the side surface of the second chamber from the first inclined portion. At this time, at least a portion of the first regenerative duct body 391 is disposed above the second intake duct.

That is, the space efficiency of the inside of the second chamber 15 may be maximized through this three-dimensional structure in which the first regenerative duct body 391 and the second intake duct 36 at least partially overlap each other in a vertical direction.

Through this, the size of a space formed by a duct flow path inside the second chamber 15 may be further reduced, and a space of the first chamber 13 may be further increased.

The second regenerative duct body 392 may include an extension 3921 that extends from the flat portion 3913 of the first regenerative duct body 391 and has one side connected to the flat portion 3913 and the other side that is in surface-contact with the second chamber 15, a second inclined portion 3923 that extends from the extension 3921 and has an inclined section inclined in an opposite direction to a direction of the inclined section of the first inclined portion 3911, and a drainage portion 3925 including a drainage hole 3924a configured to discharge condensate condensed in the second inclined portion 3923 to a tray 394 to be described below.

The extension 3921 may extend toward the side surface of the second chamber from the flat portion 3913 and may be in contact with the side surface of the second chamber.

The second inclined portion 3923 is inclined in an opposite direction to the first inclined portion from an end of the extension 3921 and extends in parallel to the second chamber 15. The height of the second inclined portion 3923 is equally provided as the height of the first inclined portion 3911, and thus the discharge hole 31b and the regenerative hole 31c may be raised to the same height. When the discharge hole 31b and the regenerative hole 31c are raised to the same height, a friction or flow loss that may occur during flowing inside the connection duct may be minimized.

The drainage portion 3925 is provided at the end of the second inclined portion and is provided to drain condensate to the tray 394.

In addition, at least a portion of the second inclined portion 3923 is constantly in contact with the side surface of the second chamber. As described below, when air heated through the heater circulates along the regenerative duct 39, the air may be condensed by the second regenerative duct body 392 including the second inclined portion 3923.

The condensate discharged from the condensed air while passing the second inclined portion 3923 may flow to the third regenerative duct body 393 along an inclination.

Accordingly, the first inclined portion 3911 described above may be inclined upward to be positioned above the air intake ducts 35 and 36, and the second inclined portion 3923 may be inclined downward to guide the condensate to the third regenerative duct body 393.

In this case, the side surface of the second chamber 15 means any one surface inside the second chamber 15 and needs to be understood to include the front and rear surfaces of the second chamber 15 as well as an inner circumference of the cabinet 1.

The third regenerative duct body 393 is bent and extends to the regenerative hole 31c from the end of the second regenerative duct body 392. The third regenerative duct body 393 may include a drainage hole formed to pass through a lower portion of the third regenerative duct body 393.

The condensate condensed and generated in the second regenerative duct body 392 may be drained downward through the drainage hole 3924a of the third regenerative duct body 393.

The regenerative duct 39 may include the tray 394 disposed below the drainage hole 3924a to collect condensate discharged from the third regenerative duct body 393. The condensate collected in the tray 394 may naturally evaporate.

The tray 394 is provided to be extended through a tray outlet (not shown) included in the cabinet 1, and thus a user may directly discard water collected in the tray 394.

Through this, it may be possible to minimize generation of mold and odor by residual condensate (residue) and manage an object more hygienically.

For smooth drainage of condensate, the tray may be located below the connection duct 31 (refer to FIG. 12).

For example, the connection duct 31 may be accommodated on a bottom surface 155 of the second chamber 15. The tray may be disposed below compared with the bottom surface 155 of the second chamber 15 by a certain distance S, and may be located between the bottom surface 155 of the second chamber 15 and the bottom surface of the cabinet 1.

As such, condensate may be drained smoothly, and a space in which the condensate is drained (a space between the bottom surface 155 of the second chamber and a bottom surface 115 of the cabinet) and a space (the second chamber 15) in which air circulates may be separated from each other, and thus the second chamber may be managed more hygienically.

In detail, air heated by the heater and passed through the air processor 325 may be introduced to the first regenerative duct body 391 and may circulate along the second regenerative duct body 392 (refer to FIG. 12).

The air flowing to the second regenerative duct body 392 may be in contact with the side surface of the second chamber along the extension 3921. The air may be condensed by heat exchange with the side surface of the second chamber while moving downward along the second inclined portion 3923.

The condensate generated while the air flows along the second inclined portion 3923 may be drained below the second chamber through a drainage hole 4924a of the drainage portion 3925 and collected to the tray 394.

Air from which condensate is removed while flowing along the second inclined portion may be introduced into the connection duct 31 through the regenerative hole 31c while flowing along the third regenerative duct body 393.

As such, according to the present disclosure, the lifetime of the air processor 325 may be increased through a regenerative mode for operating the third flow path in which the air processor 325 is regenerated.

When the air processor includes a porous material, a fouling phenomenon in which a pore is blocked by a foreign substance such as dust adsorbed by the air processor may occur. When fouling occurs, the filtration performance of the air processor may be reduced, and the lifetime of the air processor may also be reduced. Despite the regenerative mode, it may be difficult to directly remove foreign substances adsorbed in the pores of the porous material.

Therefore, there is a need for a structure for replacing the air processor from the outside of the cabinet without disassembling the circulator.

The connection duct 31 may include a connection body 311 including an accommodation surface 3111 on which any one of components of the air conditioner 32 is to be accommodated, and the replacement body 312 including a detachable surface 3121 providing a space in which the air processor 325 is detachably accommodated.

The air processor may be removably coupled to the detachable surface 3121 of the replacement body 312.

The replacement body 312 may include a replacement housing 3123 defining a portion of an outer appearance of the detachable surface 3121 and the connection duct 31 and a replacement panel 3125 extending from the replacement housing 3123 and exposed out of the cabinet 1 through the replacement hole (refer to FIG. 7).

When the replacement body 312 is accommodated in the connection duct 31, the replacement housing 3123 may extend from the outer circumferential surface of the connection body 311 to prevent air inside the connection duct 31 from being leaked to the outside.

When the replacement body 312 is accommodated in the connection duct 31, the replacement panel 3125 may be provided with a shape corresponding to the replacement hole to fill the replacement hole (not labelled but see FIG. 12).

The second chamber 15 is located below the first chamber 13, and thus the replacement hole may also be formed in the lower panel 121b of the cabinet 1.

In this case, the replacement panel 3125 may be provided to minimize a step with the lower panel 121b of the cabinet 1 and may be exposed through the replacement hole to configure a portion of the lower panel 121b (refer to FIG. 2B).

The user may pull the replacement panel toward a front surface of the cabinet and extend the air processor 325 mounted on the detachable surface 3121 to be exposed to the outside of the cabinet 1 through the replacement hole.

The user may separate the exposed air processor 325 from the detachable surface 3121 and mount a new air processor 325 on the detachable surface 3121.

Then, the user pushes the replacement body 312 toward the rear surface of the cabinet 1 such that the replacement panel 3125 is placed on the same line as the lower panel 121b, and thus the air processor 325 may be provided inside the connection duct 31.

Through this series of processes, the user may easily replace the air processor 325 without a need to disassemble the circulator 3.

The circulator 3 includes a hub 33 for communicating the intake duct, the discharge duct and the regenerative duct with the inlet hole or the discharge hole (refer to FIGS. 9 and 11).

The hub 33 may include a first hub 331 communicating the first intake duct 35 and the second intake duct 36 with the inlet hole 31a, and a second hub 332 communicating the discharge hole 31b with the first discharge duct 37 and communicating the second discharge duct 38 with the regenerative duct (first regenerative duct body).

Based on a flow of air, the first hub 331 may be disposed upstream of the inlet hole 31a and may be disposed downstream of the first intake duct 35 and the second intake duct 36.

The first hub 331 may define a three-direction flow path by forming a space in which the first intake duct 35, the second intake duct 36, and the inlet hole 31a (or the connection duct 31) communicate with each other.

That is, air introduced from the first intake duct 35 and the second intake duct 36 may be integrated by the first hub 331 and communicate with the inlet hole 31a.

The second hub 332 may be disposed downstream of the discharge hole 31b based on a flow of air, and may be disposed upstream of the first discharge duct 37, the second discharge duct 38, and the regenerative duct 39.

The second hub 332 may define a four-direction flow path by allowing the first discharge duct 37, the second discharge duct 38, the regenerative duct 39, and the discharge hole 31b (or the connection duct 31) to communicate with each other.

That is, air discharged from the discharge hole 31b may be branched in the second hub 332 and may communicate with the first discharge duct 37, the second discharge duct 38 and the regenerative duct 39.

The circulator 3 may further include a flow path converter 4 provided in the hub 33 and communicating the connection duct 31 with any one of several ducts (refer to FIG. 10).

The flow path converter 4 may include a first converter 41 that is provided in the first hub 331 and selectively communicates the first intake duct 35 and the second intake duct 36 with the connection duct through the inlet hole 31a or blocks the first discharge duct 37 and the second discharge duct 38 from the inlet hole.

The flow path converter 4 may include a second converter 42 that is provided in the second hub 332 and selectively communicates any one of the first discharge duct, the second discharge duct, and the regenerative duct with the connection duct through the discharge hole.

The flow path converter 4 may selectively convert any one of the first flow path, second flow path and third flow path to be described below by the control of a controller (not shown). An operation of the flow path converter 4 and a structure in which a flow path is converted correspondingly will be described below. The converters may be at least one of a diverter or a deflector.

FIG. 13 is a diagram showing the case in which air circulates in a circulator along a first flow path. FIG. 14 is a diagram showing the case in which air circulates in a circulator along a second flow path. FIG. 15 is a diagram showing the case in which air circulates in a circulator along a third flow path.

Referring to FIGS. 13 and 14, the circulator 3 may include a first flow path (refer to FIG. 13) including the connection duct 31 and provide to circulate air of the first object processing room 137, and a second flow path (refer to FIG. 14) including the connection duct 31 and provided to circulate air of the second object processing room 138.

The first flow path is a path in which air of the first object processing room is introduced through the first air intake port 1711, flows along the first intake duct 35, the connection duct 31, and the first discharge duct 37, and then circulates in the first object processing room 137 again through the first air discharge port 1713.

In other words, the first flow path may mean a duct structure in which air in the first object processing room 137 is circulated by the circulator 3 and may be defined to include the first intake duct 35, the connection duct 31, and the first discharge duct 37

As shown in the drawing, the first converter 41 may be controlled to communicate with the first intake duct 35 and the inlet hole 31a, and the second converter 42 may be controlled to communicate with the discharge hole and the first discharge duct 37.

As such, a state in which the first converter 41 and the second converter 42 in the flow path converter 4 are arranged to allow only circulation of air through the first flow path may be defined as a first circulation mode (i.e., which means a configuration of the flow path converter 4 based on FIG. 13).

The second flow path may be defined as a path in which air of the second object processing room 138 is introduced to the second chamber through the second air intake port 1721, flows through the second intake duct 36, the connection duct 31, and the second discharge duct 38, and circulates in the second object processing room again through the second air discharge port 1723.

In other words, the second flow path may mean a duct structure in which air of the second object processing room 138 is circulated in the second chamber 15 and may be defined to include the second intake duct 36, the connection duct 31, and the second discharge duct 38.

The flow path converter 4 may be controlled by the controller to communicate the first converter 41 with the second intake duct 36 and the inlet hole 31a and communicate the second converter 42 with the discharge hole 31b and the first discharge duct 37.

As such, a state in which the first converter 41 and the second converter 42 in the flow path converter 4 are arranged or controlled to allow only circulation of air through the second flow path may be defined as a second circulation mode (which means a configuration of the flow path converter 4 based on FIG. 14).

Each of the first object processing room 137 and the second object processing room 138 may include various sensor units (not shown) configured to measure one or more of temperature, humidity, and pollution level.

The controller may calculate air quality of the space by calculating the temperature, humidity, and pollution level of each space, and first process air in a space in an adverse condition to an object among air of the first object processing room 137 or the second object processing room 138 based on the calculated air quality.

For example, it may be assumed that a handbag made of leather, which is vulnerable to humidity or contaminants, is accommodated in the first object processing room 137, and clothing made of general cotton is accommodated in the second object processing room.

In this case, even if the air quality, such as humidity, in the first object processing room and the second object processing room is the same, the leather handbag is generally more vulnerable to temperature and humidity conditions than cotton clothing, and thus the controller may process the air in the first object processing room 137 with priority over the air in the second object processing room.

That is, the controller executes the first circulation mode first, and when the air quality in the first object processing room 137 reaches an appropriate level, the second circulation mode may be executed. Alternatively, the first object processing room 137 and the second object processing room 138 may be controlled under the same conditions, but only a flow passage circulation time may be varied, or the first object processing room 137 and the second object processing room 138 may be implemented alternately.

The controller may process the air in the first object processing room 137 or the second object processing room 138 under different conditions through the values calculated by the sensor unit.

For example, it may be assumed that the first object processing room 137 accommodates leather handbags that are vulnerable to humidity or contaminants and that the second object processing room accommodates general cotton clothing.

In this case, even if the temperatures and humidities of the first object processing room and the second object processing room are the same, the leather handbag is generally more vulnerable to temperature and humidity conditions than cotton clothing.

When the first circulation mode is executed, the controller may increase output of the circulating fan to quickly process the first object processing room 137, and when the second circulation mode is executed, relatively rapid processing is not necessary, and thus the controller may control the air conditioner to lower output of the circulating fan than in the case in which the second circulation mode is executed.

When the second object processing room 138 is divided into a larger volume than the first object processing room 137, the controller may increase the output of the circulating fan in the second circulation mode compared with the first circulation mode.

Referring to FIG. 15, the circulator 3 may include a first flow path including the connection duct 31 and provided to circulate air of the first object processing room and a third flow path including the connection duct 31 and provided to circulate air of the connection duct inside the second chamber.

The third flow path may be defined as a path in which air discharged from the connection duct 31 through the discharge hole 31b flows along the regenerative duct and then circulates in the connection duct again through the regenerative hole 31c.

In other words, the third flow path may be a duct structure in which the air of the connection duct 31 is closed and circulated within the second chamber and may be defined to include the connection duct 31 and the regenerative duct 39.

In the flow path converter 4, the first converter 41 may be controlled to block the first intake duct 35, the second intake duct 36, and the inlet hole 31a, and the second converter 42 may be controlled to align the discharge hole 31b and the regenerative duct 39 to communicate with each other.

As such, a state in which the first converter 41 and the second converter 42 in the flow path converter 4 are arranged or aligned to allow only circulation of air through the third flow path may be defined as a regenerative mode (i.e., which means a configuration of the flow path converter 4 based on FIG. 15).

The controller may control the air conditioner 32 to operate the heater while controlling the flow path converter 4 in the regeneration mode.

That is, the regeneration mode allows heated air to pass through the air processor 325, thereby evaporating moisture adsorbed on the air processor 325 or removing contaminants.

Air passing through the air processor 325 may be circulated along the regenerative flow path.

As described above, air circulating along the regenerative flow path through the regenerative mode may be condensed by heat exchange with the inner circumference surface of the second chamber 15 (refer to FIG. 12). Condensate may be drained into the tray 394.

The structure of the object treatment apparatus described above is an example of the present disclosure, and may be modified and implemented in various forms, and the scope of the present disclosure is not limited to the above-described embodiment. Therefore, when the modified embodiment includes elements of the claims of the present disclosure, it needs to be considered to fall within the scope of the present disclosure.

The present disclosure has an effect of providing an object treatment apparatus in which a first chamber of a cabinet is partitioned into a first object processing room for displaying and storing an object, and a second object processing room separated from a showcase space and configured to store an object.

The present disclosure has an effect of providing an object treatment apparatus in which air of a first object processing room and air of a second object processing room are separately circulated and the temperatures and humidifies of the respective spaces are independently managed or adjusted.

The present disclosure has an effect of providing an object treatment apparatus in which a porous material performing one or more functions of dehumidification and filtration is provided inside a second chamber that is separately disposed below a first chamber to reduce the volume of the second chamber compared with the case in which a heat pump is disposed in the second chamber.

The present disclosure has an effect of providing an object treatment apparatus including a flow path that regenerates a saturated adsorbed porous material through a closed circulation flow path provided in the second chamber.

The present disclosure has an effect in that a first flow path in which air of a showcase space flows in the second chamber, a second flow path in which air of a storage space flows, and a third flow path including a close circulation flow path regenerating a porous material are commonly passed through a circulator.

The present disclosure has an effect of providing an object treatment apparatus that selectively converts any one of the first flow path, the second flow path, and the third flow path through the circulator.

The present disclosure has an effect of providing an object treatment apparatus in which a shelf portion is detachably provided in the first chamber to store an object such as clothing and small items in terms of space efficiency.

The present disclosure has an effect of providing an object treatment apparatus that changes a coupling position of a shelf portion to fix the shelf portion to the first chamber even if a partition is disposed between the first object processing room and the second object processing room of the first chamber.

The present disclosure has an effect of providing a structure in which air ports insides the first object processing room and the second object processing room are arranged not to interfere with each other on a flow path even if a shelf portion is provided.

The present disclosure has an effect of providing an object treatment apparatus in which a porous material is to be extended out of a cabinet to be replaced.

The present disclosure has an effect in that an object accommodated inside a showcase is exposed to the outside according to intention or purpose of a user through a door window provided on a front surface of a cabinet.

The present disclosure has an effect of providing an object treatment apparatus that manages an object accommodated in a storage space while preventing the object from being exposed to the outside according to intention or purpose of a user through a partition.

The present disclosure has an effect in that a partition slides to integrate a showcase space and a storage space into each other according to the size of an accommodated object or the purpose of the user.

The present disclosure has an effect of providing an object treatment apparatus in which a lighting unit is provided inside the first chamber and on the shelf portion to maximize an aesthetic effect of being visible from the outside.

An object of the present disclosure provides an object treatment apparatus for partitioning a first chamber into a first object processing room of an object and a second object processing room separated from the first object processing room.

An object of the present disclosure provides an object treatment apparatus in which air of a first object processing room and air of a second object processing room are separately circulated and the temperatures and humidifies of the respective spaces are independently managed or adjusted.

An object of the present disclosure provides an object treatment apparatus in which a porous material performing one or more functions of dehumidification and filtration is provided inside a second chamber that is separately disposed below a first chamber to reduce the volume of the second chamber compared with the case in which a heat pump is disposed in the second chamber.

An object of the present disclosure provides an object treatment apparatus including a flow path that regenerates a saturated adsorbed porous material through a closed circulation flow path provided in the second chamber.

An object of the present disclosure provides an object treatment apparatus in which a first flow path in which air of a showcase space flows in the second chamber, a second flow path in which air of a storage space flows, and a third flow path including a close circulation flow path regenerating a porous material are commonly passed through a circulator.

An object of the present disclosure provides an object treatment apparatus that selectively converts any one of the first flow path, the second flow path, and the third flow path through the circulator.

An object of the present disclosure provides an object treatment apparatus in which a shelf portion is detachably provided in the first chamber to store an object such as clothing and small items in terms of space efficiency.

An object of the present disclosure provides an object treatment apparatus that changes a coupling position of a shelf portion to fix the shelf portion to the first chamber even if a partition is disposed between the first object processing room and the second object processing room of the first chamber.

An object of the present disclosure provides a structure in which air ports insides the first object processing room and the second object processing room are arranged to minimize interference with each other on a flow path even if a shelf portion is provided

An object of the present disclosure provides an object treatment apparatus in which a porous material is to be extended out of a cabinet to be replaced.

An object of the present disclosure provides a structure in which an object accommodated inside a showcase is exposed to the outside according to intention or purpose of a user through a door window provided on a front surface of a cabinet.

An object of the present disclosure provides an object treatment apparatus that manages an object accommodated in a storage space while preventing the object from being exposed to the outside according to intention or purpose of a user through a partition.

An object of the present disclosure provides a structure in which a partition slides to integrate a showcase space and a storage space into each other according to the size of an accommodated object or the purpose of the user.

An object of the present disclosure provides an object treatment apparatus in which a lighting unit is provided inside the first chamber and on the shelf portion to maximize an aesthetic effect of being visible from the outside.

According to an aspect of the present disclosure, an object treatment apparatus includes a cabinet having an inlet formed in a front surface thereof, a door coupled to the cabinet to open and close the inlet, a first chamber located inside the cabinet and accommodating an object put through the inlet, a second chamber located inside the cabinet and defining a space separated from the first chamber, a partition provided in the first chamber and partitioning the first chamber into a first object processing room facing the inlet and a second object processing room located behind the first object processing room, and a circulator disposed in the second chamber and circulating air of the first chamber, wherein the circulator includes a connection duct including a circulating fan circulating air and an air processor processing air, a first flow path including the connection duct and communicating with the first object processing room to circulate air of first object processing room therethrough, and a second flow path including the connection duct and communicating with the second object processing room to circulate air of the second object processing room.

The object treatment apparatus may further include a flow path converter configured to selectively communicate any one of the first flow path and the second flow path with the connection duct.

The flow path converter may include a first converter provided upstream of the connection duct based on air circulating in the circulator and communicating any one of the first flow path or the second flow path with the connection duct.

The flow path converter may include a second converter provided downstream of the connection duct and communicating the connection duct with any one of the first flow path or the second flow path.

The circulator may further include a third flow path including the connection duct and circulating air of the connection duct in the second chamber.

The object treatment apparatus may further include a flow path converter selectively communicating any one of the first flow path, the second flow path, and the third flow path with the connection duct.

Based on a flow of air circulating in the circulator, the first flow path and the second flow path may be separated upstream of the connection duct, and the first flow path, the second flow path, and the third flow path may be separated downstream of the connection duct.

The flow path converter may include a first converter disposed upstream of the connection duct based on a flow of the air and communicating any one of the first flow path and the second flow path with the connection duct or blocking the first flow path and the second flow path from the connection duct, and a second converter disposed downstream of the connection duct based on the flow of the air and communicating any one of the first flow path, the second flow path, and the third flow path with the connection duct.

The object treatment apparatus may further include a controller configured to control the flow path converter to allow only one flow path among the first flow path, the second flow path, and the third flow path, wherein the controller may be configured to control the flow path converter in a first circulation mode in which the first converter communicates the first flow path with the connection duct and the second converter communicates the connection duct with the first flow path, a second circulation mode in which the first converter communicates the second flow path with the connection duct and the second converter communicates the connection duct with the second flow path, and a regenerative mode in which the first converter blocks the first flow path and the second flow path from the connection duct and the second converter communicates the connection duct with the third flow path

The third flow path may further include a regenerative duct through which air of the connection duct circulates in the second chamber and at least a portion of which is in contact with an inner surface of the cabinet.

The first flow path may include a first air port opened through the first object processing room, and the first air port may be disposed closer to the partition than the inlet.

The first air port may include a first intake port configured to allow air of the first object processing room to flow into the connection duct, and a first discharge port configured to discharge air of the connection duct to the first object processing room, and the first intake port and the first discharge port may be arranged spaced apart from each other based on a width direction of the cabinet.

A length of the cabinet in a width direction may be greater than a length of the cabinet in a front and rear direction, and the second object processing room may further include a second air port configured to communicate the second object processing room with the connection duct to allow air of the second object processing room to flow along the second flow path and having a greater length in the width direction than a length in the front and rear direction.

The second air port may include a second intake port configured to allow air of the second object processing room to flow into the connection duct and a second discharge port configured to discharge air of the connection duct to the second object processing room, and the second intake port and the second discharge port are arranged to be spaced apart from each other in the front and rear direction.

The second chamber may be disposed downstream of the first chamber, the second air port may be provided on a bottom surface of the second object processing room, and the second discharge port may be disposed closer to a partition defining a front surface of the second object processing room than a rear surface of the second object processing room.

The connection duct may further include a replacement body including the air processor mounted thereon and provided to be extended out of the cabinet.

The door may include a door window provided to face the inlet and provided to be transmissive to view an inside of the first object processing room through the inlet.

According to another aspect of the present disclosure, an object treatment apparatus includes a cabinet having an inlet formed in a front surface thereof, a door coupled to the cabinet to open and close the inlet, a first chamber located inside the cabinet and accommodating an object put through the inlet, a second chamber located inside the cabinet and defining a space separated from the first chamber, a partition partitioning an inside of the first chamber into a first object processing room and a second object processing room, and a circulator disposed in the second chamber and circulating air of the first chamber, wherein the circulator includes a connection duct provided inside the second chamber and including a circulating fan circulating air and an air processor configured to dehumidify air, a first flow path including the connection duct and communicating with the first object processing room to circulate air of first object processing room therethrough, and a second flow path including the connection duct and communicating with the second object processing room to circulate air of the second object processing room.

The air processor may include a porous material.

The air processor may include a material that adsorbs and removes moisture or contaminants in air.

The air processor may include one or more of zeolite and activated carbon.

According to another aspect of the present disclosure, an object treatment apparatus includes a cabinet having an inlet formed in a front surface thereof, a door coupled to the cabinet to open and close the inlet, a first chamber located inside the cabinet and accommodating an object put through the inlet, a second chamber located inside the cabinet and defining a space separated from the first chamber, a partition partitioning an inside of the first chamber into a first object processing room and a second object processing room, and a circulator disposed in the second chamber and circulating air of the first chamber, wherein the circulator includes a connection duct provided inside the second chamber and including a circulating fan circulating air and an air processor configured to dehumidify air, a first flow path including the connection duct and communicating with the first object processing room to circulate air of first object processing room therethrough, a second flow path including the connection duct and communicating with the second object processing room to circulate air of the second object processing room, and a third flow path including the connection duct and closing and circulating air of the connection duct within the second chamber.

The object treatment apparatus may include a flow path converter configured to allow circulation of air through any one of the first flow path, the second flow path, and the third flow path.

The connection duct may further include a heater disposed upstream of the air process based on air circulating therein and include a controller configured to control an operation of the heater and the flow path converter, and in this case, the controller may be provided to stop the heater when controlling the flow path converter to allow air to circulate through the first flow path or the second flow path and operate the heater when controlling the flow path converter to allow air to circulate through the third flow path.

According to another aspect of the present disclosure, an object treatment apparatus includes a cabinet having an inlet formed in a front surface thereof, a door coupled to the cabinet to open and close the inlet, a first chamber located inside the cabinet and accommodating an object put through the inlet, a second chamber located inside the cabinet and defining a space separated from the first chamber, a partition partitioning the first chamber into a first object processing room and a second object processing room having a greater volume than the first object processing room, and an circulator disposed in the second chamber and circulating air of the first chamber.

The circulator may include a connection duct including a circulating fan circulating air and an air processor configured to dehumidify air, a first air port opened to the first object processing room and connected to the connection duct, and a second air port opened to the second object processing room and connected to the connection duct, and an opening area of the second air port may be formed greater than an opening area of the first air port.

The object treatment apparatus may further include a controller configured to control output of the circulating fan such that a flow amount of air through the second air port is greater than a flow amount of air through the first air port.

The object treatment apparatus may further include a flow path converter controlled by the controller and configured to communicate any one of the first air port or the second air port with the connection duct, and when controlling the flow path converter to communicate the second air port with the connection duct, the controller may perform control to further increase output of the circulating fan compared with the case in which the first air port and the connection duct communicate with each other.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The specific terms used herein are only for the convenience of description, and are not used as limited to the exemplary embodiment.

For example, the expressions such as “the same” and “identical” are not only strictly the same state, but also a state in which there is a tolerance or a difference in the range in which the same function is obtained.

For example, the expressions of relative or absolute arrangement such as “in a direction”, “according to a direction”, “parallel”, “vertically”, “center”, “concentric” or “coaxial” are not only strictly such a layout, but also a state in which there is a tolerance or a relative displacement with an angle or distance in the range in which the same function is obtained.

To explain the present disclosure, the present disclosure will be described below based on the spatial orthogonal coordinate system by X, Y, and Z axes. Each axis direction (X-axis direction, Y-axis direction, and Z-axis direction) refers to both directions in which each axis extends. The ‘+’ sign in front of each axis (+X-axis direction, +Y-axis direction, and +Z-axis direction) refers to a positive direction that is any one of both directions in which each axis extends. The‘-’ sign in front of each axis (−X-axis direction, −Y-axis direction, and −Z-axis direction) refers to a negative direction that is any one of both directions in which each axis extends.

The expressions indicating directions of “before (+X)/after (−X)/left (+Y)/right (−Y)/up (+Z)/down (−Z) mentioned below are defined based on the XYZ coordinate axes but are intended to be explained to clearly understand the present disclosure, and depending on a reference, each direction may be defined differently.

The use of the terms such as “first,” “second,” and “third” in front of components mentioned below is only to avoid confusion of the components to which they are referred, and is not related to the order, importance, or master-slave relationship between the components. For example, the disclosure that include only a second component without a first component may be implemented.

The terms of a singular form may include plural forms unless otherwise specified.

In this specification, the “object” is a concept that includes all the common clothing that requires usual management, for example, tops such as dress shirts or blouses, bottoms such as jeans, a suit, a jumper, or leather clothing. In the specification, the object includes items such as hats, scarves, handkerchiefs, bags, or dolls other than ordinary clothing and are used as an inclusive concept to include things such as watches and trinkets. However, in the specification, even if only one word of clothes, products, or goods is used, it may be understood as referring to an object in context. In other words, the object may be understood as not being determined by classification of products such as clothes, items, and goods but may be understood as including all objects as long as the objects are accommodated in an object treatment apparatus according to an embodiment of the present disclosure.

In the specification, treatment of an object needs to be understood in a comprehensive sense that includes not only separation of pollutants such as dust from the object, but also management of at least one of the temperature, humidity, deodorization or filtration of a space in which the object is stored to preserve the object in an optimal space.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An object treatment apparatus comprising:
a cabinet having an inlet formed in a front surface thereof;
a door coupled to the cabinet to open or close the inlet;
a first chamber located inside the cabinet and accommodating an object put through the inlet;
a second chamber located inside the cabinet and defining a space separated from the first chamber;
a partition provided in the first chamber and partitioning the first chamber into a first object processing room facing the inlet and a second object processing room located behind the first object processing room; and
a circulator disposed in the second chamber and circulating air of the first chamber, wherein the circulator includes a connection duct provided with a circulation fan that circulates the air introduced into the first flow path and the second flow path, and air processor that at least one of heats or dehumidifies the air, wherein
a first flow path is provided between the circulator and the first object treatment chamber,
a second flow path is provided between the circulator and the second object treatment chamber, and
the connection duct is configured to communicate with at least one of the first flow path or the second flow path.

2. The object treatment apparatus of claim 1, further comprising a flow path converter configured to selectively allow at least one of the first flow path or the second flow path to pass to the connection duct.

3. The object treatment apparatus of claim 2, wherein the flow path converter includes a first converter provided upstream of the connection duct, the first converter configured to allow at least one of the first flow path or the second flow path to pass to the connection duct.

4. The object treatment apparatus of claim 3, wherein the flow path converter includes a second converter provided downstream of the connection duct, the second converter configured to allow at least one of the first flow path or the second flow path to pass through or exit from the connection duct.

5. The object treatment apparatus of claim 1, wherein the circulator further includes a third flow path to circulates the air introduced from at least one of the first flow path or the second flow path within the second chamber.

6. The object treatment apparatus of claim 5, further comprising a flow path converter configured to selectively allow at least one of the first flow path, the second flow path or the third flow path pass to the connection duct.

7. The object treatment apparatus of claim 6, wherein the first flow path and the second flow path are separated upstream of the connection duct, and the first flow path, the second flow path, and the third flow path are separated downstream of the connection duct.

8. The object treatment apparatus of claim 6, wherein the flow path converter includes:
a first converter disposed upstream of the connection duct, the first converter configured to allow at least one of the first flow path or the second flow path to pass to the connection duct or configured to block at least one of the first flow path or the second flow path from the connection duct; and
a second converter disposed downstream of the connection duct, the second converter configured to allow at least one of the first flow path, the second flow path, or the third flow path to pass through or exit from the connection duct.

9. The object treatment apparatus of claim 8,
wherein the object treatment apparatus is configured to control the flow path converter in at least one of
a first circulation mode in which the first converter allows the first flow path to pass to the connection duct and the second converter allows the first flow path to exit from the connection duct,
a second circulation mode in which the first converter allows the second flow path pass to the connection duct and the second converter allows the second flow path to exit from the connection duct, or
a regenerative mode in which the first converter blocks the first flow path and the second flow path from the connection duct and the second converter allows the third flow path to circulate the air through the connection duct.

10. The object treatment apparatus of claim 7, wherein the third flow path includes a regenerative duct through which air of the connection duct circulates in the second chamber and at least a portion of which is in contact with an inner surface of the cabinet.

11. The object treatment apparatus of claim 1, further comprising a first air port provided closer to the partition than the inlet, the first flow path configured to pass between the first object processing room and the circulator through the first air port.

12. The object treatment apparatus of claim 11, wherein
the first air port includes a first intake port configured to allow air of the first object processing room to flow into the connection duct, and a first discharge port configured to discharge air of the connection duct to the first object processing room, and
the first intake port and the first discharge port are arranged spaced apart from each other based on a width direction of the cabinet.

13. The object treatment apparatus of claim 1, further comprising a second air port having a width longer than the length in the front-to-back direction, the second flow path configured to pass between the second object processing room and the circulator through the second air port.

14. The object treatment apparatus of claim 13, wherein
the second air port includes a second intake port configured to allow air of the second object processing room to flow into the connection duct and a second discharge port configured to discharge air from the connection duct to the second object processing room, and
the second intake port and the second discharge port are arranged to be spaced apart from each other in the front and rear direction.

15. The object treatment apparatus of claim 14, wherein
the second chamber is disposed downstream of the first chamber,
the second air port is provided on a bottom surface of the second object processing room, and
the second discharge port is disposed closer to a partition configured to define a front surface of the second object processing room than a rear surface of the second object processing room.

16. The object treatment apparatus of claim 1, wherein the connection duct further includes a replacement body provided with the air processor mounted thereon and configured to extend beyond the front surface of the cabinet.

17. The object treatment apparatus of claim 1, wherein the door includes a door window provided to face the inlet and provided to be transmissive to allow viewing of an inside of the first object processing room.

18. The object treatment apparatus of claim 1, wherein the air processor includes a material that adsorbs and removes moisture or contaminants in air.

19. The object treatment apparatus of claim 18, wherein the air processor includes at least one of zeolite or activated carbon.

20. The object treatment apparatus of claim 18, wherein the air processor includes a porous material.

21. An object treatment apparatus comprising:
a cabinet having an inlet formed in a front surface thereof;
a door coupled to the cabinet to open or close the inlet;
a first chamber located inside the cabinet and accommodating an object placed through the inlet;
a second chamber located inside the cabinet and defining a space separated from the first chamber;
a wall configured to move in at least one direction to spatially create a first object processing room and a second object processing room inside the first chamber; and
a circulator disposed in the second chamber and circulating air of the first chamber, the circulator having a connection duct provided with a circulating fan configured to circulate air and an air processor configured to dehumidify air,
wherein based on an operation of the circulating fan, at least one of a first air flow exists between the connection duct of the circulator and the first object processing room or a second flow exists between the connection duct of the circulator and the second object processing room.

22. An object treatment apparatus comprising:
a cabinet having an inlet formed in a front surface thereof;
a door coupled to the cabinet to open or close the inlet;
a first chamber located inside the cabinet and accommodating an object placed through the inlet;
a second chamber located inside the cabinet and defining a space separated from the first chamber;
a partition partitioning an inside of the first chamber into a first object processing room and a second object processing room; and
a circulator disposed in the second chamber and circulating air of the first chamber,
wherein the circulator includes
a connection duct provided inside the second chamber and provided with a circulating fan to circulate air and an air processor configured to dehumidify air,
a first flow path communicating with connection duct and the first object processing room to circulate air of first object processing room therethrough,
a second flow path communicating with connection duct and the second object processing room to circulate air of the second object processing room, and
a third flow path closed to the first and second object processing rooms to circulate air of the connection duct within the second chamber.

23. An object treatment apparatus comprising:
a cabinet having an inlet formed in a front surface thereof;
a door coupled to the cabinet to open or close the inlet;
a first chamber located inside the cabinet and accommodating an object placed through the inlet;
a second chamber located inside the cabinet and defining a space separated from the first chamber;
a partition partitioning the first chamber into a first object processing room and a second object processing room, the second object processing room having a greater volume than the first object processing room; and
a circulator disposed in the second chamber and circulating air of the first chamber, wherein the circulator includes
a connection duct having a circulating fan configured to circulate air and an air processor configured to dehumidify air,
a first air port communicating with the first object processing room and connected to the connection duct,
a second air port communicating with the second object processing room and connected to the connection duct, wherein a opening size of the second air port is greater than an opening size of the first air port.
